(19) United States
(12) Patent Application Publication
(10) Pub. No.: US 2012/0000445 A1
(43) Pub. Date: Jan. 5, 2012

(54) Method and Control Apparatus for Controlling a High-Pressure Fuel Supply Pump

(75) Inventors: Jonathan BORG, Erding (DE); Masanori Watanabe, Muenchen (DE); Kenichiro Tokuo, Hitachinaka (JP)

(73) Assignee: Hitachi, Ltd., Tokyo (JP)

(21) Appl. No.: 13/171,595

(22) Filed: Jun. 29, 2011

(30) Foreign Application Priority Data
Jun. 30, 2010 (EP) 10168022.1
Aug. 11, 2010 (EP) 10172572.9

(51) Int. Cl. F02M 37/06; F02D 41/26

(52) U.S. Cl. 123/497

(57) ABSTRACT

The present invention relates to a control apparatus 700 for controlling a high-pressure fuel supply pump 100, a computer program product comprising computer program code means configured to adapt a control apparatus 700 for controlling a high-pressure fuel supply pump 100, and a method for controlling a high-pressure fuel supply pump 100 configured to supply pressurized fuel to an internal combustion engine. The high-pressure fuel supply pump 100 comprises a normally-closed type solenoid actuated intake valve 110 configured to be opened or kept open by magnetic force. A control current IC of the solenoid actuated intake valve 110 is controlled for opening the solenoid actuated intake valve 110 by applying a control voltage VC to the solenoid actuated intake valve 110. Controlling a control current IC of the solenoid actuated intake valve 110 comprises increasing the control current IC to a first control current value IC1 for energizing the solenoid actuated intake valve 110. Controlling a control current IC of the solenoid actuated intake valve 110 for opening the solenoid actuated intake valve 110 according to the present invention further comprises reducing the control current IC from the first control current value IC1 to a second control current value IC2 being smaller than the first control current value IC1.

### CLAIM OF PRIORITY

The present application claims priority from European Patent Application No. P10168022.1 filed on Jun. 30, 2010 and No. P10172572.9 filed on Aug. 11, 2010, the content of which are hereby incorporated by reference into this application.

### BACKGROUND OF THE INVENTION

1. Field of the Invention

The present invention relates to a method for controlling a high-pressure fuel supply pump that is configured to supply pressurized fuel to an internal combustion engine and to a control apparatus for controlling such a high-pressure fuel supply pump. Furthermore, the present invention relates to a computer program product comprising computer program code means configured to adapt a control apparatus, in particular an engine control unit, such that the control apparatus is adapted to control the high-pressure fuel supply pump.

The present invention specifically relates to a method and a control apparatus for controlling a high-pressure fuel supply pump comprising a normally-closed type solenoid actuated intake valve that is configured to be opened and/or kept open by magnetic force, in particular by energizing a solenoid of the normally-closed type solenoid actuated intake valve. This is to be distinguished from high-pressure fuel supply pumps comprising a normally-open type solenoid actuated intake valve that is configured to be closed and/or kept closed by magnetic force, in particular by energizing a solenoid of the normally-open type solenoid actuated intake valve.

The present invention relates to controlling a control current of the solenoid actuated intake valve for opening the solenoid actuated intake valve by applying a control voltage or a control current to the solenoid actuated intake valve, wherein controlling a control current of the solenoid actuated intake valve comprises increasing the control current to a first control current value for energizing the solenoid actuated intake valve, in particular increasing the control current to the first control current value for energizing the solenoid actuated intake valve before a movable plunger reciprocating in a compression chamber of the high-pressure fuel supply pump between a bottom dead center position (BDC) and a top dead center position (TDC) reaches the bottom dead center position (BDC) at the end of an intake stroke of the movable plunger.

2. Description of the Related Art

High-pressure fuel supply pumps configured to supply pressurized fuel to an internal combustion engine can be used in connection with fuel supply systems which are based on a direct injection operation according to which fuel is injected directly into a combustion chamber of an internal combustion engine by means of injectors. The pressurized fuel to be directly injected into the combustion chamber of the internal combustion engine is pressurized by means of the high-pressure fuel supply pump.

For example, from EP 1 898 085 A2, there is known a high-pressure fuel supply system for supplying pressurized fuel to an internal combustion engine, the system comprising a normally-closed type solenoid actuated intake valve that is configured to be opened or kept open by means of a magnetic force generated by energizing the solenoid of the solenoid actuated intake valve. The term “normally-closed” refers to a type of valve which is closed in a de-energized state, i.e. when there is no control current or control voltage applied to the solenoid of the solenoid actuated intake valve.

However, in such high-pressure fuel supply systems, especially in low-rotational speed conditions of the motor such as for example during an idle operation of the internal combustion engine, the dominant operation noise is the noise emitted from the solenoid actuated intake valve, in particular, the noise generated when closing and opening the valve, e.g. when an intake valve member of the solenoid actuated intake valve comes in contact with a valve seat in the fully closed position of the valve. Accordingly, it is desirable to provide a fuel supply system with a solenoid actuated intake valve allowing for a reduced operation noise.

In EP 1 898 085 A2, the problem of reducing the operation noise of a normally-closed solenoid actuated intake valve has been addressed and it was proposed to utilize a hydraulic pressure difference between upstream and downstream side of the valve for opening the valve by hydraulic force before energizing the solenoid of the intake valve. Still, there is made an ongoing effort for finding further optimization strategies and optimization concepts for further reducing the operation noise of the normally-closed solenoid actuated intake valve while allowing for reliable operation.

### SUMMARY OF THE INVENTION

It is an object of the present invention to reduce the operating noise of a high-pressure fuel supply pump that is configured to supply pressurized fuel to an internal combustion engine and comprises a normally-closed type solenoid actuated intake valve which is configured to be opened or kept open by magnetic force.

[1] According to a first aspect of the present invention, a method for controlling a high-pressure fuel supply pump is proposed for controlling a high-pressure fuel supply pump that is configured to supply pressurized fuel to an internal combustion engine. The high-pressure fuel supply pump comprises a normally-closed type solenoid actuated intake valve which is configured to be opened and/or kept open by magnetic force, in particular when applying a control voltage or control current to the solenoid actuated intake valve for opening and/or keeping open the solenoid actuated intake valve while the solenoid actuated intake valve remains closed by means of a biasing member when no hydraulic pressure acts on the solenoid actuated intake valve and no control voltage or control current is applied to the solenoid actuated intake valve (i.e. a normally closed type solenoid actuated intake valve).

According to the present invention, the method for controlling a high-pressure fuel supply pump comprises controlling a control current of the solenoid actuated intake valve for opening the solenoid actuated intake valve by applying a control voltage or the control current to the solenoid actuated intake valve, wherein controlling the control current of the solenoid actuated intake valve comprises increasing the control current to a first control current value for energizing the solenoid actuated intake valve, in particular increasing the control current to a first control current value for energizing the solenoid actuated intake valve before a movable plunger, which reciprocates in a compression chamber of the high-pressure fuel supply pump between a bottom dead center position (BDC) and a top dead center position (TDC), reaches the bottom dead center (BDC) at the end of an intake stroke of the movable plunger.

The present invention is characterized in that controlling the control current of the solenoid actuated intake valve for opening the solenoid actuated intake valve further comprises reducing the control current from the first control current value to a second control current value being smaller than the first control current value, in particular reducing the control current from the first control current value to the second control current value before the movable plunger reciprocating in a compression chamber of the high-pressure fuel supply pump between the bottom dead center position (BDC) and the top dead center position (TDC) reaches the bottom dead center (BDC) at the end of an intake stroke of the movable plunger.

Accordingly, for reducing the operation noise of the solenoid actuated intake valve, the control current for opening the normally-closed type solenoid actuated intake valve is controlled such that it initially increases to a first control current value for energizing the solenoid actuated intake valve while being thereafter reduced again to a smaller second control current value. Decreasing the control current in a solenoid coil of the solenoid actuated intake valve results in a reduction of the magnetic force acting on the solenoid actuated intake valve so that the movement of the intake valve in the opening direction can be decelerated by means of the biasing force of a biasing member of the normally-closed type solenoid actuated intake valve acting in the closing direction of the solenoid actuated intake valve.

Due to such a deceleration of the movement of the intake valve in the opening direction, the speed of the intake valve at the time of hitting a mechanical stop at the fully-opened position, such as e.g. a restricting member, stopper, or the valve seat at the fully-opened position can be reduced so that the corresponding impact noise can be further reduced. In other words, the movement in the opening direction of the solenoid actuated intake valve can be decelerated (or the acceleration thereof towards the fully-opened position can at least be reduced) so that the intake valve can land smoothly on a mechanical stop such as e.g. the valve seat, which makes it possible to significantly reduce the impact noise.

Reducing the operation noise by controlling the control current such that it is initially increased to a first control current value and thereafter decreased to a smaller second control current value for opening the solenoid actuated intake valve has the further advantage that the operation noise can be reduced by merely modifying the applied current control without any particular requirements regarding modifications in the mechanical design of the high-pressure fuel supply pump. Since changes and modifications to the mechanical design are normally very expensive and laborious to develop or implement, reducing the noise by modifying the applied concept of current control of the solenoid is significantly less cost expensive than modifications to the mechanical design. This is especially advantageous in view of the high production number in the mass production of parts in the automobile industry.

In particular, since today's high-pressure fuel supply pumps are generally automatically controlled by means of an electronic engine control unit, an optimized algorithm of current control can be implemented in the control of the existing high-pressure fuel supply pumps by reprogramming or adapting the engine control unit, e.g. by means of software modifications.

Furthermore, by precisely controlling the control current applied to the solenoid of the solenoid actuated intake valve, the amount of energy that is supplied to the solenoid can be accurately controlled so as to precisely control acceleration and/or deceleration of the intake valve during the movement in the opening direction. That is, controlling the control current allows to directly affect the amount of generated magnetic biasing force so that the increase and/or decrease of the magnetic biasing force can be controlled e.g. based on an increase of decrease of the hydraulic force acting on the intake valve.

It is to be noted that “current control” in the sense of the present invention can be implemented according to various concepts for current control such as e.g. PWM control or threshold current control. The basic concept of the present invention does not depend on the specific realization of controlling the control current as long as the control current is controlled for opening the solenoid actuated intake valve by firstly increasing the control current to the first control current value for energizing the solenoid and thereafter decreasing the control current to a smaller second control current value for decelerating the movement of the intake valve or at least reducing the acceleration thereof, in particular before the intake valve reaches the fully-opened position.

For example, controlling of the control current can be performed by means of PWM (pulse width modulation) voltage control, i.e. by applying a PWM control voltage to the solenoid of the solenoid actuated intake valve, wherein the value and/or development of the control current in the solenoid can be controlled by controlling the duty cycle of the PWM control voltage signal. Also, it is possible to control the control current applied to the solenoid by changing the frequency of the PWM control signal together with the duty cycle of the PWM voltage control signal. Accordingly, it is possible to use PWM control for controlling the control current by combining changing the duty cycle of the PWM voltage control signal and changing the frequency of the PWM control for controlling the control current in the solenoid.

Besides the possibility of controlling the control current by means of PWM voltage control, the control current can be also directly controlled by either controlling the control voltage or the control current directly e.g. with a continuously applied control voltage (a rather analog control of the control current in comparison to the PWM control in which the applied control voltage is digitally switched between a low voltage value, i.e. an OFF condition of the PWM voltage control, and a high voltage value, i.e. an ON condition of the PWM voltage control, e.g. between 0 and a maximal control voltage Vmax), e.g. by means of an amplifier. For example, current control can be achieved by means of threshold current control where the current is regulated to a specific threshold without requiring modulation such as e.g. pulse with modulation of the voltage signal. The value of the control current can also be directly regulated by means of an integrated circuit.

It is to be noted that there exist concepts in the prior art according to which the control current supplied to the solenoid is reduced for avoiding thermal overload in the solenoid by reducing the control current after the intake valve has already opened, i.e. after the intake valve has already reached the fully-opened position. That is, in such control concepts, the control current is not reduced still in the step of controlling the control current for opening the solenoid actuated intake valve but the control current is only reduced during an operation phase in which the normally-closed intake valve is already kept fully closed by means of the magnetic force, e.g. during the phase of output of high-pressurized fuel through discharge valve of the high-pressure fuel supply pump (cf. e.g. DE 10 2004 016554 A1).

In contrast to these known concepts, according to the present invention, the decrease of the control current from the first control current value to the smaller second control current value is performed still as part of the step of controlling the control current for opening the solenoid actuated intake valve making it possible to reduce operation noise of the high-pressure fuel supply pump. The control concepts as, for example, described in DE 10 2004 016554 A1 are not suitable for reducing the operation noise at all since the control current is reduced only after the intake valve has already reached the fully-opened position, i.e. the impact at the end of the opening motion of the intake valve when the valve comes into contact with the valve seat or another mechanical stopper at the fully-opened position has already occurred.

[2] Preferably, the control current from the first control current value is reduced to the second control current value before the solenoid actuated intake valve is fully opened, in particular before the movable plunger reciprocating in a compression chamber of the high-pressure fuel supply pump between the bottom dead center position (BDC) and the top dead center position (TDC) reaches the bottom dead center (BDC) at the end of an intake stroke of the movable plunger.

[3] According to the present invention, the second control current value is smaller than the than the first control current value and may be a non-zero current value being smaller than the first control current value or the control current may be even reduced down to zero or at least down to being substantially zero, in particular before the movable plunger reciprocating in a compression chamber of the high-pressure fuel supply pump between the bottom dead center position (BDC) and the top dead center position (TDC) reaches the bottom dead center position (BDC) at the end of an intake stroke of the movable plunger for ensuring that the solenoid actuated intake valve becomes fully opened before said movable plunger reaches said bottom dead center position.

[4] According to a preferred embodiment of the present invention, controlling a control current of the solenoid actuated intake valve for opening the solenoid actuated intake valve further comprises increasing the control current from the second control current value to a third control current value being larger than the second control current value, preferably before the movable plunger reaches the bottom dead center position (BDC). According to this preferred aspect of the invention, it is possible to significantly reduce the operation noise of average mass products high-pressure fuel supply pumps and solenoid actuated intake valves while it can be further made sure that each of a series of mass product parts can be reliably controlled so as to reliably reach the fully-opened position, in particular prior to the beginning of the compression phase, even if there may occur mass production deviations.

That is, high-pressure fuel supply pumps and solenoid actuated intake valves underlying the present invention are generally objects of mass production being produced at high production numbers. Regarding such the parts of mass production series, at least minor mass production deviations between single parts can occur. According to the present invention, it is possible to optimize the control of the control current of the solenoid actuated intake valve e.g. based on an average solenoid actuated intake valve of the mass production series such as e.g. a prototype of the mass production series or an example part of the mass production series, wherein the above described preferable aspect of the present invention including the increasing the control current from the second control current value to a third control current value being larger than the second control current value, the operation control can be made more reliable even in view of possibly occurring minor mass production deviations between parts of the mass production series.

For example, it is possible to use a minimal control current value for the second control current value being smaller than the first control current value such that the minimal control current value is still sufficient to open an “average” solenoid actuated intake valve of the mass production series before the compression plunger reaches the bottom dead center position so that the “average” intake valve of the mass production series can reach the fully-opened position before the time when the plunger starts again moving upward towards the top dead center position, i.e. so that the compression phase of pressurizing fuel in the compression chamber starts after the intake valve is actually in the fully-opened position and can be kept open in the fully-opened position. In case the intake valve should not be already in the fully-opened position at the time when the movable compression plunger starts pressurizing fuel in the compression chamber when starting the movement from bottom dead center position towards the top dead center position, the minimal control current value for the “average” solenoid actuated intake valve might not be sufficient to fully open the intake valve and keep it open since the fuel pressure may act against the intake valve in a closing direction thereof opposite to the magnetic force of the solenoid actuated intake valve when the compression plunger is moving towards the top dead center position (TDC).

Specifically, since the fuel pressure in the compression chamber may increase with increasing speed of the movable compression plunger and fuel will spill out of the partially open intake valve, the magnetic force may not be sufficient to keep the intake valve open due to the reduced magnetic force, e.g. due to the gap between a core and an anchor of the partially opened electromagnetic solenoid actuated intake valve. For this reason, in order to cope with possible deviations in mass production and make possible a reliable control of the operation of the high-pressure fuel supply pump even in view of possible mass production deviations, it is may be preferable that the control current is increased again from the second control current value to a third control current value being larger than the second control current value in order to make sure that the intake valve can be fully opened before the time of the beginning of the compression phase by increasing again the magnetic force caused by the increase of the control current from the second to the third control current value in case the smaller second control current value may not be sufficient to fully open the intake valve due to possible mass production deviations.

Accordingly, average mass production parts on the basis of which the second control current value is set can be operated at a significantly reduced operation noise while it can be further ensured that each part of a mass production series can be reliably opened up to the fully-opened position even in case of mass production deviations.

[5] Preferably, the high-pressure fuel supply pump further comprises a compression chamber and a movable plunger reciprocating in the compression chamber between a bottom dead center position (BDC) and a top dead center position (TDC) for pressurizing fuel in said compression chamber when said solenoid actuated intake valve is fully closed and said movable plunger moves towards the top dead center position (TDC). Preferably, increasing the control current from the second control current value to the third control current value is performed before the movable plunger reaches the bottom dead center position (BDC) for ensuring that the solenoid actuated intake valve becomes fully opened before said movable plunger reaches said bottom dead center position (BDC). Accordingly, it can be ensured that the intake valve is in the fully-opened position before start of the compression phase in which the movable plunger moves from the bottom dead center position (BDC) towards the top dead center position (BDC).

[6] According to a preferred embodiment of the present invention, the third control current value is a target control current value for keeping the solenoid actuated intake valve fully opened, in particular said third control current value is a target control current value for keeping the solenoid actuated intake valve fully opened after said movable plunger has reached said bottom dead center position. Accordingly, the third control current value is already a target control current value which is maintained for keeping the solenoid actuated intake valve in the fully-opened position until it shall be closed for starting the output phase in which pressurized fuel is discharged to the internal combustion engine, in particular through a discharge valve of the high-pressure fuel supply pump to a common rail of the internal combustion engine. Depending on the pump design, the step of increasing the control current to the third control current value may additionally guarantee that the intake valve is kept open against the increasing fluid pressure during the compression phase (i.e. after the movable plunger has reached the bottom dead center position BDC and is moving again towards the top dead center position TDC).

Alternatively, controlling a control current of the solenoid actuated intake valve further comprises reducing said third control current value to a target control current value after solenoid actuated intake valve is fully opened for keeping the solenoid actuated intake valve fully opened for reducing energy consumption, in particular controlling a control current of the solenoid actuated intake valve further comprises reducing said third control current value after said movable plunger has reached said bottom dead center position (BDC) to a target control current value after the solenoid actuated intake valve is fully opened for keeping the solenoid actuated intake valve fully opened after said movable plunger has reached said bottom dead center position (BDC), said target control current value being smaller than the third control current value for reducing energy consumption, preferably while still being sufficient for ensuring that the intake valve can remain open during the compression phase (i.e. after the movable plunger has reached the bottom dead center position BDC and is moving again towards the top dead center position TDC).

Accordingly, the third control current value which is an increased control current value for ensuring that the intake valve reaches the fully-opened position before the movable plunger reaches the bottom dead center position (BDC) as described above is then again reduced to a smaller target control current value which is then maintained for keeping the solenoid actuated intake valve fully open until it is intended to be closed for starting the output phase in which pressurized fuel is discharged from the compression chamber via a discharge valve.

This makes it possible to reduce the energy consumption of the high-pressure fuel supply pump since the target control current value that is maintained during a spill phase is smaller than the third current control value. The target current control value may be equal to the second control current value. Also, since the control current is reduced again from the third control current value to the target control current value after the movable plunger has reached the bottom dead center position (BDC), thermal overload of the solenoid can be efficiently avoided. Here, spill phase refers to the operation phase in which the solenoid actuated intake valve is kept in the fully-opened position so that fuel is spilled out of the compression chamber still through the intake valve while the movable plunger already moves towards the top dead center position (TDC) in a compression phase so that no fuel is pressurized and no pressurized fuel is discharged through a discharge valve of the solenoid actuated intake valve.

[7] Controlling a control current of the solenoid actuated intake valve may be performed by controlling a duty cycle of a PWM voltage signal supplied to the solenoid actuated intake valve, by controlling a duty cycle and a frequency of a PWM voltage signal supplied to the solenoid actuated intake valve, or by controlling the value of a voltage signal supplied to the solenoid actuated intake valve, in particular by directly controlling the value of the voltage signal supplied to the solenoid actuated intake valve e.g. by means of an amplifier means.

As already mentioned above, the basic idea of the present invention relates to the control of the control current being supplied to the solenoid of the solenoid actuated intake valve which can be realized in different ways of controlling the control current such as e.g. controlling the duty cycle of a PWM voltage signal when the solenoid actuated intake valve is controlled via PWM control or by controlling a frequency and a duty cycle of the PWM voltage signal of the PWM control when the solenoid actuated intake valve is controlled via PWM control. Besides the possibility of control of a voltage signal by means of PWM control (i.e. applying a voltage signal being switched between two discrete voltage signal values corresponding to the ON and OFF condition of the PWM signal), the control current can also be directly controlled by directly regulating the control voltage and/or the control current, e.g. by means of an amplifier and/or an integrated circuit. It is possible to directly control the control current via current threshold control, wherein the control current is, for example, directly controlled by means of an integrated circuit. Directly regulating the control current by means of an amplifier or integrated circuit may have the advantage that the current can be precisely controlled while PWM control may lead to ripples in the evolution of the control current due to the on and off switching of the PWM voltage signal. However, ripples and effects of ripples of the control current controlled by a PWM voltage signal can also be efficiently reduced by increasing the frequency of the PWM voltage signal. Another advantage of PWM control is that it can be easily implemented and common electronic engine control units are already configured for supplying a PWM control signal and can be easily adapted to be configured to perform a control according to the present invention, e.g. by means of software and/or hardware modifications.

[8] Preferably, controlling a control current of the solenoid actuated intake valve further comprises applying an initial voltage pulse for increasing (preferably rapidly increasing) the control current to the first control current value, and applying a first PWM voltage signal after applying the initial voltage pulse for reducing the control current from the first control current value to the second control current value. The initial voltage pulse can be embodied by a constant voltage signal being shortly applied embodying the initial voltage pulse or as an initial PWM voltage signal embodying the initial voltage pulse, wherein the duty cycle of the initial PWM voltage signal is preferably larger than the duty cycle of the first PWM voltage signal. In particular, the duty cycle of the initial PWM voltage signal may be 100% or at least substantially 100%.

According to this preferred embodiment, PWM control is used for controlling the control current supplied to the solenoid actuated intake valve. At first, for increasing the control current up to the first control current value, an initial voltage pulse for increasing the control current can be applied. When using PWM control, the initial voltage pulse may be realized by a PWM voltage signal pulse having 100% or at least substantially 100% duty cycle. After applying this initial voltage pulse, a first PWM voltage signal is applied having preferably a duty cycle smaller than 100% (in particular smaller than the duty cycle of the initial voltage pulse) and in particular adapted such that the control current applied to the solenoid of the intake valve can be reduced from the first control current value to the smaller second control current value.

[9] Preferably, controlling a control current of the solenoid actuated intake valve further comprises applying a second PWM voltage signal after applying the first PWM voltage signal for increasing the control current from the second control current value to a third control current value being larger than the second control current value, in particular wherein said first PWM voltage signal has a smaller duty cycle than the second PWM voltage signal. The second PWM voltage signal may have a duty cycle up to 100% or substantially up to 100%.

According to this preferred aspect, for controlling the control current such that it is again increased from the second control current value to the third control current value, e.g. in order to ensure that the intake valve reaches the fully-opened position before the movable plunger reaches the bottom dead center position even in case of mass production deviations or the like, a further second PWM voltage signal can be applied with a higher duty cycle than the first PWM voltage signal for increasing the voltage current again. The second PWM voltage signal can be set such that the control current reaches a target control current value or even a current being larger than a final target control current for keeping the intake valve at the fully-opened position during the spill phase when the movable compression plunger moves upward in an upward stroke towards the top dead center position until the intake valve shall be closed for pressurizing fuel in the compression chamber and discharging pressurized fuel via a discharge valve of the high-pressure fuel supply pump.

[10] The first PWM voltage signal may be switched to the second PWM controlled voltage signal. According to another preferred embodiment of the present invention, the first PWM voltage signal may be changed according to a stepped PWM control to the second PWM voltage signal. Then, at least a third PWM voltage signal may be applied after the first PWM voltage signal and before the second PWM voltage signal. The duty cycle of the third PWM voltage signal may then be larger than the duty cycle of the first PWM controlled voltage signal and smaller than the duty cycle of the second PWM controlled voltage signal. According to yet another preferred embodiment of the present invention, the duty cycle of the first PWM voltage signal may be continuously or iteratively increased according to a ramped up PWM control to the duty cycle of the second PWM controlled voltage signal.

In case the control current is rapidly increased from the second control current value up to the third control current value, while an average mass production high-pressure fuel supply pump would already have reached the fully-opened position during the phase of applying the second control current value or at least shortly thereafter, there may occur situations in which the solenoid actuated intake valve may not have reached the fully-opened position due to mass production deviations but will be fully opened by the increase of the control current from the second to the third control current value. When this increase from the second to the third control current value is performed rapidly, it may lead to a situation in which the intake valve hits the valve seat or a mechanical stop with a higher speed, thereby generating an undesired impact noise in those rare cases.

However, according to the above mentioned embodiments in which the increase of the control current from the second to the third control current value is performed more slowly, and smoothly by means of a stepped or ramped up PWM control, even in such situations, the intake valve reaches the fully-opened position at a slower speed so that the impact noise can be significantly reduced even in rare cases in which the solenoid actuated intake valve is not fully opened by a control current corresponding to the second control current value.

According to an embodiment utilizing stepped PWM control, after applying the first PWM voltage signal, plural PWM control signals respectively having an increased duty cycle compared to the duty cycle of the respective previous PWM control signal can be applied for iteratively increasing the duty cycle of the PWM control voltage for increasing the control current to the third control current value more slowly.

According to an alternative embodiment, the PWM control can be performed by utilizing a ramped up PWM control in which the duty cycle of the applied PWM voltage signal is increased continuously or iteratively for increasing the control current to the third control current value. This can be, for example, achieved in that the durations of the PWM control being in the ON condition are increased continuously or iteratively and/or the durations of the PWM control being in the OFF condition are decreased continuously or iteratively. Furthermore, a substantially continuous increase of the control current from the second control current value to the third control current value may be also achieved by continuously or iteratively changing the frequency of the PWM control signal or also a combination of continuously or iteratively changing the duty cycle and continuously or iteratively increasing the frequency of the PWM voltage signal.

In case of direct current control, e.g. by means the above described threshold current control by means of an amplifier and/or an integrated circuit, the control current can be increased at a smaller slope, e.g. such that the third control current value is reached at or approximately at (preferably before or slightly before) the timing at which the movable compression plunger reaches the bottom dead center position (BDC).

[11] Preferably, controlling a control current of the solenoid actuated intake valve may further comprise at least one of setting a timing of the start of applying the initial voltage pulse, setting a duration of applying the initial voltage pulse, and setting a timing of applying the first PWM voltage signal and/or a duration of applying the first PWM voltage signal. Setting of timings and durations of said initial voltage pulse and said first PWM voltage signal may be performed for controlling a magnetic force of the solenoid actuated intake valve in dependence of a hydraulic force acting in an opening direction of the solenoid actuated intake valve and a biasing force acting in a closing direction of the solenoid actuated intake valve.

When utilizing PWM control for controlling the control current, the control can be easily performed and, for optimizing the control, plural control parameters can be set and/or optimized for reducing the impact noise at the time the intake valve reaches the fully closed position. The control parameters are preferably set such that the magnetic force (i.e. the magnetic force being generated by energizing the solenoid of the solenoid actuated intake valve), the biasing force biasing the intake valve in the direction of closing the valve as generally the case in a normally-closed solenoid intake valve, and the hydraulic force (i.e. the hydraulic force that is generated by a difference of pressure upstream and downstream of the intake valve when the movable compression plunger is in a downward stroke towards bottom dead center position, thereby increasing the volume of the compression chamber and decreasing the pressure therein, generating a hydraulic force on the intake valve acting in the opening direction of the intake valve) are balanced and optimized for reducing the impact noise when the intake valve reaches the fully-opened position.

For example, the amplitude of the hydraulic force generally depends on the speed of the movement of the compression plunger in the compression chamber, wherein the compression plunger accelerates at first during the movement from the top dead center position until it decelerates again when approaching the bottom dead center position, i.e. the speed of the movement of the compression plunger corresponds to a periodic function (depending on the specific profile of a rotating cam driving the plunger movement), e.g. preferably approximately corresponding to a sine wave, wherein the maximum speed may be reached approximately half way between top dead center position and bottom dead center position (in case of a sine wave, the maximum speed would be reached half way between top dead center position and bottom dead center position). On the other hand the magnetic force generated by energizing the solenoid of the solenoid actuated intake valve generally depends on the applied control current as well as the distance between parts being attracted by the magnetic force such as e.g. an anchor and a core of the solenoid actuated intake valve. On the other hand, the biasing force depends on the position of the intake valve and may generally linearly increase from the fully closed position to the fully-opened position.

The movement of the intake valve results from the sum of the above mentioned forces, i.e. the sum of the biasing force, the hydraulic force, and the magnetic force. The hydraulic force as well as the magnetic force may act in the opening direction of the intake valve while the biasing force, such as e.g. a spring force, may act in the closing direction of the intake valve.

Preferably, the time evolution of the magnetic force is balanced with the time evolution of the hydraulic force when the compression plunger moves from the top dead center position to the bottom dead center position, wherein the method according to the present invention preferably comprises setting of control parameters such as e.g. setting the timing of starting the increase of the control current, setting the timing of reaching the first control current value, and/or setting the value of the first control current value.

For example, when utilizing PWM control, at least one of the time of the start of applying the initial voltage pulse, the duration of applying the initial voltage pulse, and the timing of applying the first PWM voltage signal and/or a duration thereof can be set in order to balance the time evolutions of the hydraulic force and the magnetic force, preferably including additionally balancing the forces with the linearly increasing biasing force, while the intake valve is displaced towards the fully-opened position.

Setting the above mentioned timings and/or durations allows for optimization in order minimize the average impact speed when reaching the fully-opened position (i.e. to ensure a soft landing of the intake valve at the fully-opened position) for reducing the operation noise of the high-pressure fuel supply pump. Furthermore, parameters of the pump design, such as e.g. a cam profile as well as the feed pressure of the low-pressure fuel supplied to the high-pressure fuel supply pump may be considered for optimization since these parameters of the pump design can affect the hydraulic force and the behavior thereof.

Preferably, the above mentioned setting of timing and durations is performed such that the resultant force being the sum of the hydraulic force, the magnetic force, and the biasing force is a resultant force acting in the direction of opening the valve being above a threshold force value that is suitable to keep the intake valve in the fully-opened position (e.g. a force that is sufficient to keep the general average intake valve of a mass production series open after the intake valve has reached the fully-opened position). It may be necessary to consider that the hydraulic force generally has the maximum value at a time at which the speed of the movement of the compression chamber during the downward stroke is maximal, i.e. approximately halfway between a top dead center position and bottom dead center position, and thereafter, the hydraulic force generally decreases again. Then, in case the intake valve has not reached the fully-opened position, e.g. due to a possible mass production deviation, at a timing at which the hydraulic force acting in the opening direction of the intake valve decreases again due to the decrease of the speed of the movement of the compression plunger towards the bottom dead center position, and a larger magnetic force will be required to move the intake valve still up to the fully-opened position. According to a preferred embodiment, even in such a situation, a significantly reduced impact speed and reduced impact noise can be achieved if the timing of applying the initial voltage pulse is set to an earlier value, e.g. to a timing before the hydraulic force reaches the maximum value.

Accordingly, at earlier times during the downward stroke of the compression plunger, a smaller magnetic force may be sufficient to move the intake valve up to the fully-opened position since the hydraulic force acting in the opening direction of the intake valve is large at this timing of the middle of the stroke of the compression plunger substantially halfway between the top dead center position and bottom dead center position.

[12] Preferably, controlling a control current of the solenoid actuated intake valve may further comprise setting a timing of applying the second PWM voltage signal and/or a duration of applying the second PWM voltage signal. Setting of timings and durations of said initial voltage pulse, said first PWM voltage signal, and said second PWM voltage signal may be performed for controlling said magnetic force in dependence of said hydraulic force and said biasing force.

By setting the timing and/or duration of applying the second PWM voltage signal for increasing again the control current from the second control current value to the third control current value, it can be ensured that the intake valve will always reach the fully-opened position, even in case of possible mass production deviations of the high-pressure fuel supply pump and/or solenoid actuated intake valve.

[13] Preferably, the timing of applying the initial voltage pulse may be set before the occurrence of a maximum hydraulic force acting in an opening direction of the solenoid actuated intake valve. In other words, the timing of applying the initial voltage pulse may be set before the occurrence of a maximum speed of the movement a compression plunger reciprocating in a compression chamber of the high-pressure fuel supply pump in the direction towards the bottom dead center position.

The setting of timings and durations of the above mentioned parameters is preferably set such that the timing of reaching the fully-opened position occurs when the hydraulic force is at the maximum value, e.g. at a timing at which the speed of the movement of the movable compression plunger towards the bottom dead center position is substantially maximal. Preferably, the timing of applying the initial voltage pulse is set to a timing before the hydraulic force arrives at the maximum value, in other words before the speed of the movement of the compression plunger towards the bottom dead center position becomes maximal. Furthermore, the duration of applying the initial voltage pulse (and/or the time of applying the first PWM voltage signal as mentioned below) is preferably set such that the intake valve substantially approaches the fully-opened position at a time when the hydraulic force is at a maximum value or in other words at a timing at which the movement of the compression plunger towards the bottom dead center position reaches the maximum value at the middle of the stroke. Thereafter, the control current is preferably reduced by applying the first PWM control signal (or alternatively, the control current can be reduced even down to zero or substantially zero), so that the magnetic force generated by the solenoid is reduced by the decrease of the control current so that the resulting force acting on the intake valve is varied such that the speed towards the fully-opened position is decelerated or at least the acceleration thereof is significantly decreased.

[14] Preferably, the setting of timings and durations of said initial voltage pulse and said first PWM voltage signal or said first and second PWM voltage signals are set such that the solenoid actuated intake valve reaches its fully opened condition at a timing when said PWM control is in a low current condition e.g. in an OFF condition of the PWM signal applied to the solenoid actuated intake valve. This is especially advantageous for PWM control at low frequency (e.g. at PWM control frequencies in the range of approximately 100 to 1000 Hz, preferably 200 to 600 Hz, preferably at substantially 400 Hz) as e.g. most commonly used in single-switch PWM control.

If the control current is controlled via PWM control, at least if PWM control with low frequency is used, there may occur ripples in the evolution of the control current due to the switching on and off of the PWM voltage signal, wherein preferably the setting of timings and durations of the initial voltage pulse and the first PWM voltage signal or the first and second PWM voltage signals are set such that the solenoid actuated intake valve reaches the fully-opened position at a timing when the ripples of the control current are below the current average value which is a low current condition, i.e. a condition in which the control current is slightly below a PWM controlled average control current value, in other words approximately when the PWM signal applied to the solenoid is in an off condition.

[15] Preferably, a timing of the start of the increase of the control current to the first control current value for energizing the solenoid actuated intake valve is set to a timing before the occurrence of a maximum hydraulic force acting in an opening direction of the solenoid actuated intake valve. This can be e.g. achieved by setting the timing and duration of the initial voltage pulse as mentioned above for PWM control or also for other types of current control such as e.g. the above-mentioned directly regulating current control such as e.g. current threshold control. This is especially advantageous for PWM control at low frequency (e.g. at PWM control frequencies in the range of approximately 100 to 1000 Hz, preferably 200 to 600 Hz, preferably at substantially 400 Hz) as e.g. most commonly used in single-switch PWM control [16] According to a preferred embodiment, said solenoid actuated intake valve is an integrated-type solenoid actuated intake valve having an intake valve member and an intake valve plunger being formed as a unit, i.e. intake valve member and an intake valve plunger are fixed to each other or are even integrally formed. According to an alternative preferred embodiment, the solenoid actuated intake valve can also be a separate-type solenoid actuated intake valve having an intake valve member and an intake valve plunger being formed as separate members. Then, the magnetic force of the solenoid actuated intake valve preferably acts on the intake valve plunger. For the separate-type solenoid actuated intake valve, a timing of the start of the increase of the control current to the first control current value for energizing the solenoid actuated intake valve is preferably set to a timing after said intake valve member starts moving caused by a hydraulic force acting in an opening direction of the intake valve member, in particular such that the intake valve plunger preferably comes in contact with the intake valve member when the intake valve member moves in the opening direction of the intake valve member.

In an integrated-type solenoid actuated intake valve, the magnetic force acts preferably on the intake valve plunger but may also act on the intake valve member in an opening direction of the intake valve while the biasing force for closing the integrated-type solenoid intake valve may act on the intake valve plunger and/or the intake valve member in the closing direction of the intake valve while the hydraulic force may predominantly act on the intake valve member. The resulting force resulting from the magnetic force, the hydraulic force, and the biasing force may act on the unitary body comprising in an integrally formed manner the intake valve member as well as the intake valve plunger or on a unitary body which comprises fixed to each other the intake valve plunger and the intake valve member. Accordingly, the resultant force may act such that the intake valve member as well as the intake valve plunger move together.

However, according to an alternative embodiment, the present invention can also be applied for controlling a separate-type solenoid actuated intake valve having an intake valve plunger and an intake valve member formed as separate members that can be displaced independently of each other. In such separate-type solenoid actuated intake valves, the hydraulic force acts generally on the intake valve member and the magnetic force generally acts on the intake valve plunger in a direction of opening the intake valve. There may be at least provided a biasing member for biasing the intake valve member in the closing direction, while another biasing member may act on the intake valve plunger. It is possible, that the biasing member acting on the intake valve plunger is configured such that it generates a biasing force that either acts in a closing direction or in an opening direction of the intake valve.

Since the separate-type solenoid actuated intake valve is realized as a normally-closed intake valve according to the invention, in case a biasing member acts on the intake valve member, it may generate a biasing force acting in the direction of opening the valve. In case the biasing member acting on the intake valve plunger acts in the opening direction, the biasing member acting on the intake valve member may be configured such that it generates a large biasing force (particularly larger than the biasing force acting on the intake valve plunger) so that the overall biasing force in a situation in which the intake valve member and the intake valve plunger are in contact with each other and there is no hydraulic force or magnetic force, is acting in the closing direction so that the intake valve member is kept in the fully closed position against the biasing force acting on the intake valve plunger.

In the case of separate-type solenoid actuated intake valves, the hydraulic force generally only acts on the intake valve member as mentioned above, resulting in a movement of the intake valve member in the opening direction of the intake valve. Especially for separate-type solenoid actuated intake valve configurations, in which a biasing force acts on the intake valve plunger in the direction of closing the valve, the timing of the start of the increase of the control current, e.g. by setting a timing of an initial voltage pulse, may be set to a timing after the intake valve member has already started movement in the direction of opening the valve by means of a hydraulic force (preferably such that the intake valve plunger being moved in direction of opening the valve by the increasing magnetic force will come in contact with the intake valve member when the intake valve member is already moving in the opening direction due to the hydraulic force). Accordingly, a first impact noise that is typically generated when the intake valve plunger comes in contact with the intake valve member in such separate-type solenoid actuated intake valves can be significantly reduced. A second impact noise that is generated when the intake valve member together with the intake valve plunger reach the fully-opened position can be significantly reduced by controlling the control current applied to the solenoid of the intake valve according to one or more of the above mentioned aspects of the present invention.

[17] According to a second aspect of the present invention, a control apparatus for controlling a high-pressure fuel supply pump configured to supply pressurized fuel to an internal combustion engine is proposed. The control apparatus according to the second aspect of the present invention is adapted to control a control current of the solenoid actuated intake valve for opening the solenoid actuated intake valve according to at least one of the above described embodiments according to the first aspect of the present invention.

Specifically, the control apparatus according to the second aspect of the present invention is adapted to control a high-pressure fuel supply pump that is configured to supply pressurized fuel to an internal combustion engine. The high-pressure fuel supply pump comprises a normally-closed type solenoid actuated intake valve which is configured to be opened or kept open by magnetic force, in particular when applying a control voltage to the solenoid actuated intake valve for opening or keeping open the solenoid actuated intake valve while the solenoid actuated intake valve remains closed by means of a biasing member when no hydraulic pressure acts on the solenoid actuated intake valve and no control voltage is applied to the solenoid actuated intake valve (i.e. a normally closed type solenoid actuated intake valve).

According to the present invention, the control apparatus according to the second aspect of the present invention is adapted to control a control current of the solenoid actuated intake valve for opening the solenoid actuated intake valve by applying a control voltage to the solenoid actuated intake valve. The control apparatus according to the second aspect of the present invention is adapted to control the control current of the solenoid actuated intake valve such that the control current is increased to a first control current value for energizing the solenoid actuated intake valve, in particular the control current is increased to a first control current value for energizing the solenoid actuated intake valve before the movable plunger reciprocating in the compression chamber of the high-pressure fuel supply pump between the bottom dead center position (BDC) and the top dead center position (TDC) reaches the bottom dead center (BDC) at the end of an intake stroke of the movable plunger.

The control apparatus according to the second aspect of the present invention is characterized in that it is adapted to control the control current of the solenoid actuated intake valve for opening the solenoid actuated intake such that the control current is reduced from the first control current value to a second control current value being smaller than the first control current value, in particular the control current is reduced from the first control current value to the second control current value before the movable plunger reciprocating in a compression chamber of the high-pressure fuel supply pump between the bottom dead center position (BDC) and the top dead center position (TDC) reaches the bottom dead center (BDC) at the end of an intake stroke of the movable plunger.

Moreover, according to preferred embodiments of the second aspect of the present invention, the control apparatus may be further adapted to control the control current of the solenoid actuated intake valve according to one or more of the above-described preferred embodiments of the first aspect of the present invention.

[18] According to a third aspect of the present invention, a computer program product is proposed that comprises computer program code means configured to adapt a control apparatus, in particular an engine control unit, such that the control apparatus is adapted to control a control current of the solenoid actuated intake valve for opening the solenoid actuated intake valve according to one or more of the embodiments described in connection with the first aspect of the present invention. That is, the computer program product comprises computer program code means configured to adapt a control apparatus, in particular an engine control unit, such that the control apparatus embodying a control apparatus as described above in connection with the second aspect of the present invention.

The above described features and aspects of the method according to the invention and preferred features and aspects thereof also apply to the control apparatus as well as the computer program product described above and advantages as described with reference to the aspects of the method still apply and are omitted for reasons of conciseness of the present specification. The preferred features and aspects described above can be modified or combined in any way.

### BRIEF DESCRIPTION OF THE DRAWINGS

FIG. 1 shows an example of a fuel supply system comprising a high-pressure fuel supply pump for supplying high-pressure fuel to an internal combustion engine comprising a normally-closed solenoid actuated intake valve.

FIG. 2A shows an example of a normally-closed solenoid actuated intake valve in the fully closed position, while FIG. 2B shows the normally-closed solenoid actuated intake valve of FIG. 2A in the fully-opened position.

FIG. 3 illustrates an example of conventional control of a normally-closed solenoid actuated intake valve relating to the background of the present invention.

FIG. 4 shows the evolution of a voltage control signal VC and the evolution of the control current IC according to a conventional method for controlling a high-pressure fuel supply pump comprising a normally-closed solenoid actuated intake valve.

FIG. 5A shows a typical schematic diagram of a system having two switches for PWM control applied to a solenoid.

FIG. 5B schematically illustrates the PWM control signal supplied to the solenoid of FIG. 5A and the control current resulting therefrom.

FIG. 6A shows a typical schematic diagram of a system having one switch for PWM control applied to a solenoid.

FIG. 6B schematically illustrates the PWM control signal supplied to the solenoid of FIG. 6A and the control current resulting therefrom.

FIG. 7 shows the evolution of a voltage control signal VC and the evolution of the control current IC according to a method according to a first embodiment of the present invention for controlling a high-pressure fuel supply pump comprising a normally-closed solenoid actuated intake valve.

FIG. 8 schematically illustrates the evolution of the control current IC and the valve movement according to the first embodiment of the present invention.

FIG. 9 shows the evolution of a voltage control signal VC and the evolution of the control current IC according to a method according to a second embodiment of the present invention for controlling a high-pressure fuel supply pump comprising a normally-closed solenoid actuated intake valve.

FIG. 10 schematically illustrates the evolution of the control current and the valve movement according to the second embodiment of the present invention.

FIG. 11 shows the evolution of a voltage control signal VC and the evolution of the control current IC according to a method according to a third embodiment of the present invention for controlling a high-pressure fuel supply pump comprising a normally-closed solenoid actuated intake valve.

FIG. 12 shows the evolution of a voltage control signal VC and the evolution of the control current IC according to a method according to a fourth embodiment of the present invention for controlling a high-pressure fuel supply pump comprising a normally-closed solenoid actuated intake valve.

FIG. 13 schematically illustrates the evolution of the control current IC and the valve movement according to the fourth embodiment of the present invention.

FIG. 14 shows a comparison of the conventional control method with an embodiment of the present invention.

FIG. 15 schematically shows an example of a separate-type solenoid actuated intake valve.

FIG. 16 illustrates an example of conventional control of a normally-closed solenoid actuated intake valve relating to the background of the present invention for a separate-type solenoid actuated intake valve.

FIG. 17 schematically illustrates the evolution of the control current IC and the valve movement according to the fifth embodiment of the present invention.

FIG. 18 shows the evolution of a voltage control signal VC and the evolution of the control current IC according to a method according to a sixth embodiment of the present invention for controlling a high-pressure fuel supply pump comprising a normally-closed solenoid actuated intake valve.

FIG. 19 shows an alternative evolution of a PWM voltage control signal.

### DETAILED DESCRIPTION OF THE INVENTION

Preferred embodiments of the present invention will be described below with reference to the Figures. It is to be noted that the described features and aspects of the embodiments may be modified or combined to form further embodiments of the present invention. In the description of the preferred embodiments, the control current and/or the PWM voltage signals which could generate such a control current will be shown exemplarily. However, it should be noted that any implementation for current control can be used, especially PWM control or direct current control, e.g. by using an amplifier (maybe in connection with closed loop current control). Furthermore, it is to be noted that the actual current profile may exhibit additional features, such as current ripples (especially with PWM control) or a dip in the current when the intake valve impacts with a mechanical stop. Such features are omitted in the figures for simplicity, and only the local mean current is displayed (as a smooth trace).

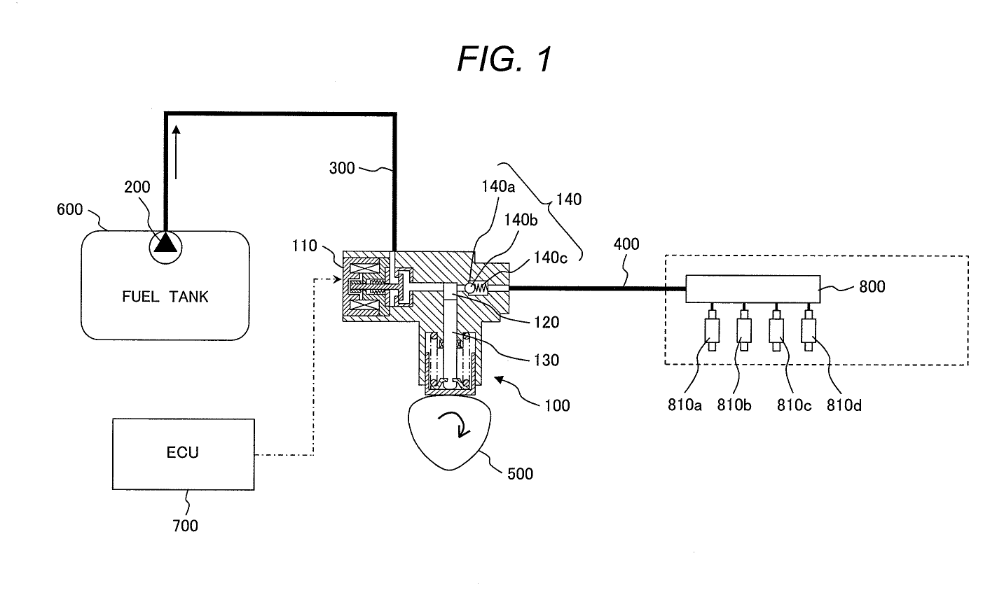

FIG. 1 shows an example of a fuel supply system comprising a high-pressure fuel supply pump with a normally-closed solenoid actuated intake valve. The high-pressure fuel supply pump 100 is configured to supply high-pressure fuel to an internal combustion engine for direct injection of high-pressurized fuel directly into a combustion chamber of the internal combustion engine.

The fuel supply system comprises a fuel tank 600 and a low-pressure fuel pump 200 for supplying the high-pressure fuel supply pump 100 with low-pressure fuel from the fuel tank via an intake pipe 300. After pressurization of the fuel in the high-pressure fuel supply pump 100, the pressurized fuel is supplied to a common rail 800 via a discharge pipe 400 to be then directly injected into compression chambers of the internal combustion engine by means of four injectors 810a, 810b, 810c, and 810d. The present invention is however not limited to fuel supply systems having four injectors but can be generally applied to systems with one or more common rails, each common rail having one or more injectors.

The high-pressure fuel supply pump comprises a normally-closed-type solenoid actuated intake valve 110, a compression chamber 120, a movable compression plunger 130 reciprocating in the compression chamber 120 between a top dead center position and a bottom dead center position.

The high-pressure fuel supply pump further comprises a discharge valve 140 comprising a discharge valve seat 140a, a discharge valve member 140b, and a discharge valve spring 140c, generating a biasing force acting on the discharge valve member 140b in the closing direction of the discharge valve 140, wherein the discharge valve 140 is in the fully closed state, when the discharge valve 140b is in contact with the discharge valve seat 140a.

The reciprocating motion of the movable compression plunger 130 is driven via the rotation of cam 500. When the movable plunger moves from the top dead center position towards the bottom dead center position, the volume of the compression chamber 120 is increased, and after the movable compression plunger 130 has reached the bottom dead center position, it starts moving again towards the top dead center position, thereby decreasing again the volume of the compression chamber 120 which is minimal when the movable compression plunger reaches the top dead center position.

Low-pressure fuel is taken in to the compression chamber 120 from the low-pressure fuel pipe 300 via the normally-closed solenoid actuated intake valve 110, and discharged at high-pressure via the high-pressure fuel pipe 400 via discharge valve 140. The amount and timing of discharged pressurized fuel is controlled by controlling the control current applied to the solenoid of the solenoid actuated intake valve 110 which is controlled by the engine control unit 700.

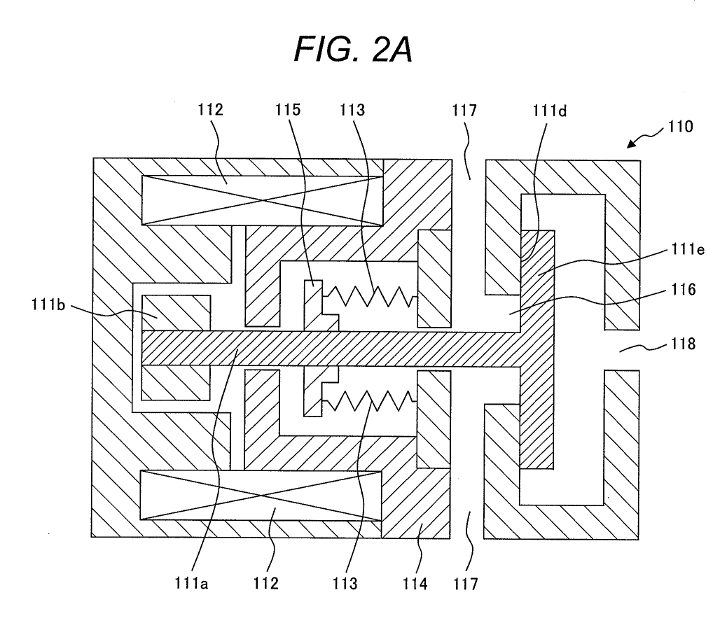

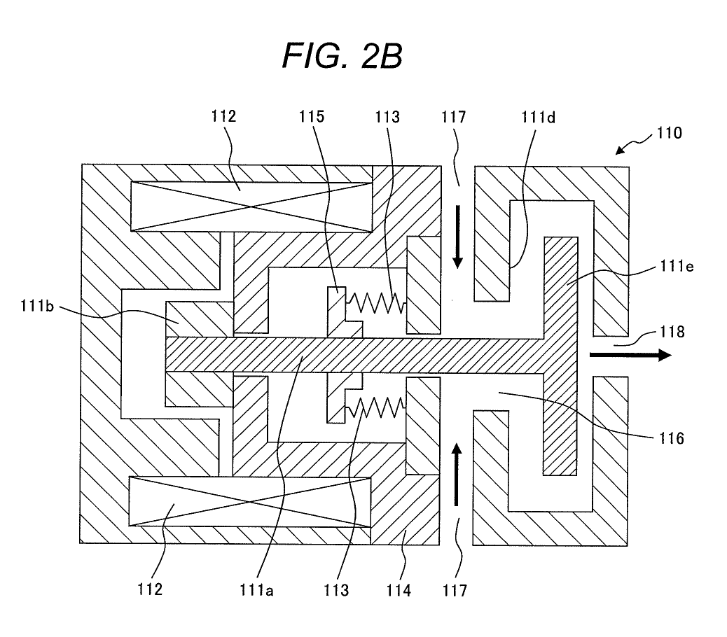

FIGS. 2A and 2B show different states of an example of a “normally closed” type solenoid actuated intake valve 110. In FIG. 2B, the “normally closed” type solenoid actuated intake valve 110 is shown in the open state, e.g. when a control voltage or a control current is applied to coil 112 for keeping the valve at the fully-opened position, and in FIG. 2A, the “normally closed” type solenoid actuated intake valve 110 is shown in the fully closed state, i.e. when no control voltage or control current is applied to the coil 112, i.e. there is no magnetic force acting on the intake valve since the solenoid actuated intake valve 110 is in the de-energized state, and there is no hydraulic pressure, i.e. there is no pressure difference between upstream and downstream of the valve so that there is no hydraulic force acting on the valve. Then, the solenoid actuated intake valve 110 is kept closed by means of a biasing force acting in the closing direction of the intake valve that is generated by a biasing member such as e.g. spring 113.

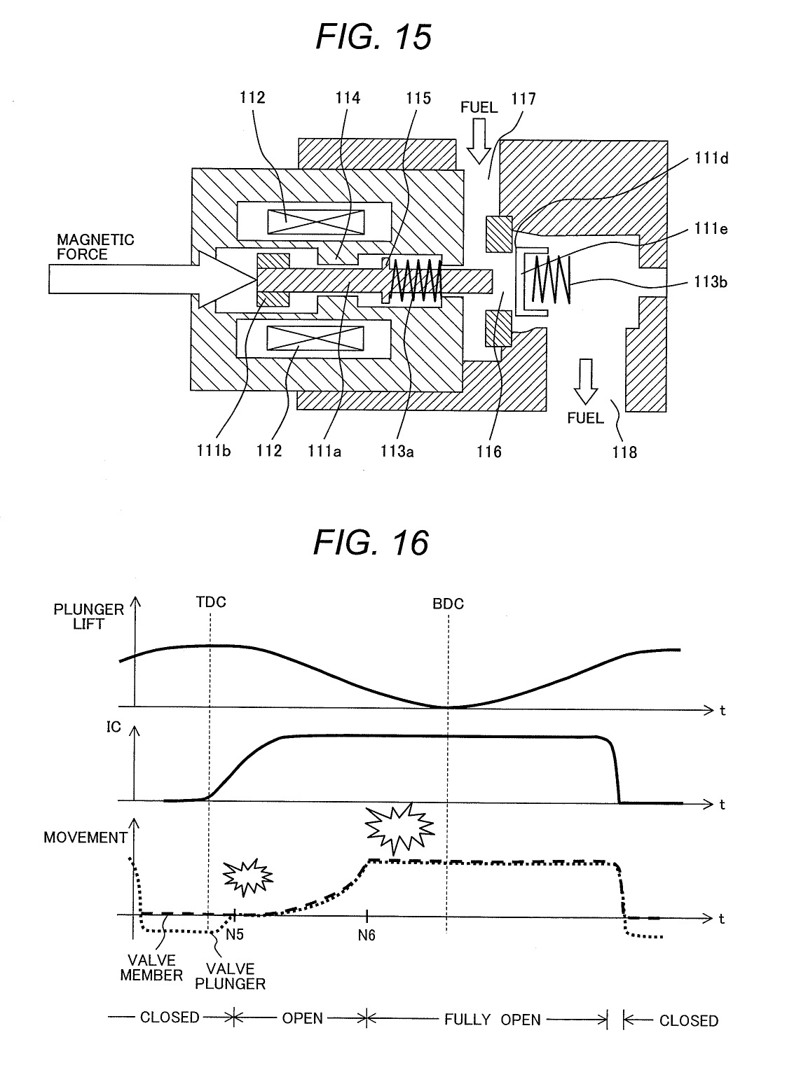

The “normally closed” solenoid actuated intake valve 110 in FIGS. 2A and 2B comprises a movable intake valve plunger 111a and an intake valve member 111e. In FIGS. 2A and 2B, the movable intake valve plunger 111a and the intake valve member 111e are exemplarily formed as a unitary body, however, the movable intake valve plunger 111a and the intake valve member 111e can also be formed as separate bodies (cf. e.g. FIG. 15).

An anchor 111b is provided at the other end of the movable intake valve plunger 111a, e.g. at the end on the side opposite of the movable intake valve plunger 111a than the intake valve member 111e. When current is applied to the coil 112, the anchor 111b and a core 114 of the solenoid valve are attracted to each other by magnetic force so that the movable intake valve plunger 111a is displaced in the direction of opening the valve until the anchor 111b and the core 114 (or other two or more members in other embodiments) come in contact so that the displacement of the movable intake valve plunger 111a is restricted. The position of the intake valve when the anchor 111b and the core 114 have come in contact so that the displacement of the movable intake valve plunger 111a is restricted is referred to as fully-opened position since the intake valve cannot be opened further.

As long as current is applied to the coil 112, the anchor 111b and the core 114 remain attracted to each other so as to stay in contact so that the valve can be kept open in that the intake valve member 111e is kept away from intake valve seat 111d. Accordingly, low-pressure fuel can be drawn from the low-pressure system via the intake passage 117 as indicated by the arrow and be delivered to the compression chamber 120 of the high-pressure fuel supply pump via the intake port 118 as further indicated by the arrow. Of course, non-pressurized fuel can also be spilled backwards through the intake port 118 via the intake passage 117 to the low-pressure fuel system as long as the valve is kept open by applying current to coil 112, when the compression plunger 130 in the compression chamber 120 is in an upward stroke so as to decrease the volume of the compression chamber 120.

However, when there is no current applied to the coil 112, the spring 113 biases the movable intake valve plunger 111a in the direction of closing the valve until the intake valve member 111e comes in contact with the intake valve seat 111d for closing the valve as shown in FIG. 2A. Accordingly, in an upward stroke of the compression plunger 130 in the compression chamber 120, fuel cannot spill out through the intake port 118 and fuel is pressurized in the compression chamber 120 so as to be discharged through the discharge valve 140 at high pressure. On the other hand, when there is no current applied to the coil 112, and the compression plunger 130 is in an intake stroke (downward stroke) so as to increase the volume of the compression chamber 120, the fuel pressure in the compression chamber 120 decreases in comparison to the pressure of fuel in the intake passage 117 which is connected to the low-pressure fuel system so that a hydraulic force is generated which can cause the displacement of the intake valve member 111e in the direction of opening the valve against the biasing force of the spring 113 even without applying current to the coil 112. The hydraulic force can either cause a full displacement of the movable intake valve plunger 111a and/or the intake valve member 111e until the anchor 111b comes in contact with the core 114 or a displacement which is not a full displacement of the movable intake valve plunger 111a and/or the intake valve member 111e until the anchor 111b comes in contact with the core 114.

Thereafter, when current is applied to the coil 112, i.e. when the solenoid is energized, the magnetic force causes the valve to open and/or be kept open. Especially in a structure as shown in FIGS. 2A and 2B, where the movable intake valve plunger 111a is displaced together with the intake valve member 111e before the current is applied to the coil 112, a noise level and vibrations can be efficiently reduced during the operation of the “normally closed” solenoid actuated intake valve. Here, this is achieved in that the movable intake valve plunger 111a and the intake valve member 111e are formed as a unitary body. However, the movable intake valve plunger 111a and the intake valve member 111e can also be formed as separate bodies which are fixed to each other or as separate bodies where the movable intake valve plunger 111a and the intake valve member 111e are biased by a biasing mechanism to the direction of closing the valve, where the movable intake valve plunger 111a is further biased in the direction of the intake valve member 111e so that the movable intake valve plunger 111a is displaced by a biasing force in the direction of opening the valve, when the intake valve member 111e is displaced to the direction of opening the valve by means of the hydraulic force.

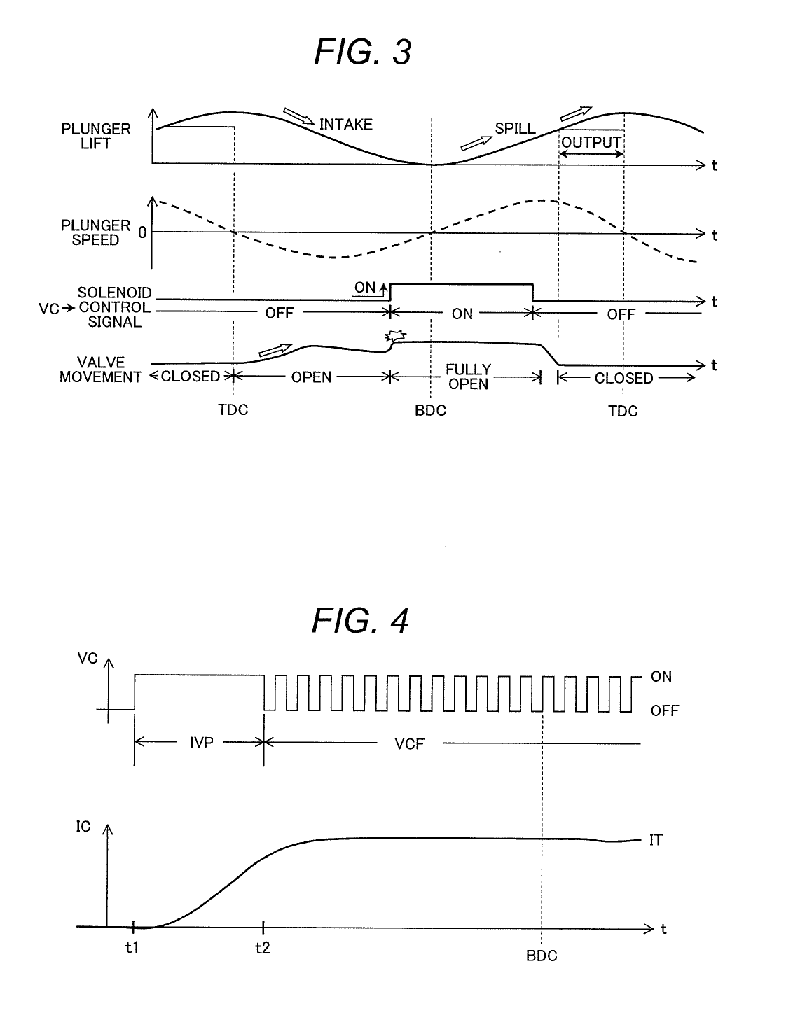

FIG. 3 illustrates the conventional control of a high-pressure fuel supply pump 100 comprising a normally-closed solenoid actuated intake valve 110. In the uppermost row of FIG. 3, the time evolution of the movement of the movable compression plunger 130 is shown (referred to as “plunger lift”). The movable compression plunger 130 performs a motion similar to a sine wave (or other periodic functions in other embodiments, depending on the cam profile) and reciprocates between a top dead center position (at the times indicated by “TDC”) and a bottom dead center position (at a time referred to as “BDC” in FIG. 3). Accordingly, as indicated in the second row from the top in FIG. 3, the speed of the movable compression plunger 130 is such that the movable compression plunger 130 has zero speed at the time at which the movable compression plunger 130 is at the top dead center (TDC) or at the bottom dead center (BDC). The maximum value of the speed of the motion of the compression plunger 130 is obtained in the middle of the stroke of the compression plunger 130, i.e. since the compression plunger 130 moves according to a sine wave in this embodiment, the maximum value of the speed is reached half way between the top dead center position and the bottom dead center position or between the bottom dead center position and the top dead center position. The movement of the compression plunger 130 between top dead center position (TDC) and bottom dead center position (BDC) is sometimes referred to as downward stroke or intake stroke, while the movement of the compression plunger 130 between bottom dead center position (BDC) and top dead center position (TDC) is sometimes referred to as upward stroke, output stroke or discharge stroke.

As illustrated in the second row from the bottom in FIG. 3, a voltage control signal VC is applied before the compression plunger 130 reaches the bottom dead center position in a downward stroke (referred to as “ON” in FIG. 3) for opening and keeping open the solenoid actuated intake valve 110 at the beginning of the discharge stroke, so that fuel can be spilled out of the compression chamber 120 via the solenoid actuated intake valve 110 caused by the decreasing volume of the compression chamber 120 (substantially without pressurizing fuel in the compression chamber 120).

In the bottom row of FIG. 3, the corresponding time evolution of the valve movement of the solenoid actuated intake valve (particularly of the intake valve member 111e) is shown. Shortly after the movable compression plunger 130 has reached to top dead center position TDC and starts again moving towards the bottom dead center position BDC, the volume of the compression chamber 120 is reduced thereby leading to a pressure difference upstream and downstream of the intake valve member 111e of the solenoid actuated intake valve 110. As soon as the hydraulic force generated by the pressure difference overcomes the biasing force of the spring 113, the hydraulic force acts to open the solenoid actuated intake valve 110 by displacing the intake valve member 111e in the opening direction of the solenoid actuated intake valve 110.

The amplitude of the hydraulic force depends on the speed of the movement of the compression plunger 130 and increases until the maximum of the speed of the movement of the compression plunger 130 is reached while the hydraulic force is thereafter decreased again so that the hydraulic force decreases and the intake valve member 111e is displaced again in the direction of closing the valve due to the biasing force of spring 113 until the solenoid of the solenoid actuated intake valve 110 is energized by switching ON the control voltage signal supplied to the coil 112 of the solenoid actuated intake valve 110.

When switching ON the voltage control signal VC, a control current in coil 112 generates the magnetic force acting on the intake valve. The generated magnetic force causes the intake valve member 111 to be displaced up to the fully-opened position in which the intake valve member 111e comes in contact with intake valve seat 111d, thereby generating an impact noise which is the dominating noise in the operation of the high-pressure fuel supply pump having a normally-closed solenoid actuated intake valve 110, especially in conditions of a low rotational speed of the internal combustion engine such as, for example, in an idle condition thereof.

The solenoid actuated intake valve 110 is kept in the fully-opened position by means of the magnetic force attracting anchor 111b and core 114, wherein the fuel in the combustion chamber 120 is spilled out of the compression chamber 120 via the fully opened solenoid actuated intake valve 110, until the control voltage VC supplied to the solenoid coil 112 is switched OFF. Thereafter, the intake valve closes due to the biasing force generated by the spring 113 in the closing direction of the intake valve 110 and the hydraulic force.

At a time at which the intake valve 110 reaches the fully-closed position, the output phase for discharging pressurized fuel from the compression chamber 120 to the internal combustion engine via the discharge valve 140 starts. Specifically, since the movable compression plunger 130 is still moving towards the top dead center position TDC and the volume of the compression chamber 120 is further reduced, the pressure of the fuel in the compression chamber 120 increases until it overcomes the biasing force of the discharge valve spring 140c acting in the closing direction of the discharge valve 140, thereby opening the discharge valve 140 so that pressurized fuel can be delivered via the discharge valve 140 and discharge pipe 400 to the common rail 800. The output phase of discharging pressurized fuel via the discharge valve 140 ends as soon as the movable plunger 130 reaches the top dead center position TDC. The next intake phase starts as soon as the movable plunger 130 starts to move again in the direction of the bottom dead center position BDC.

FIG. 4 shows a conventional PWM control for opening a normally-closed solenoid actuated intake valve before the movable plunger 130 reaches the bottom dead center BDC as shown in FIG. 3. The upper row in FIG. 4 illustrates the control voltage signal VC applied to the solenoid of the solenoid actuated intake valve being switched ON and OFF between a minimal and a maximal control voltage value (wherein the minimal value may be zero, i.e. no voltage is applied to the solenoid, or the minimal value may be a non-zero value being smaller than the maximal value). The bottom row of FIG. 4 shows the evolution of the control current IC corresponding to the control voltage signal VC of the upper row of FIG. 4. At first, an initial voltage pulse IVP is switched ON at a timing t1 and applied to the solenoid coil 112 of the solenoid actuated intake valve 110 until a time t2, wherein t1 and t2 are times before the time at which the movable plunger 130 reaches to bottom dead center position BDC. By time t2, a PWM control signal VCF at a duty cycle less than 100% is applied so as to keep the control current IC supplied to the solenoid coil 112 of the solenoid actuated intake valve 110 at a substantially constant current control target value IT which is then used for generating the substantially constant magnetic force for keeping the intake valve 110 in the fully-opened position during the spill phase described above. Here, the initial voltage pulse signal IVP applied between time t1 and t2 (e.g. a PWM signal at 100% or substantially 100% duty cycle) causes a fast energization of the solenoid while the PWM voltage signal VCF is applied with a duty cycle below 100% in order to avoid that the control current is increased to amplitudes that could possibly lead to thermal overload in the solenoid and possibly waste electric energy.

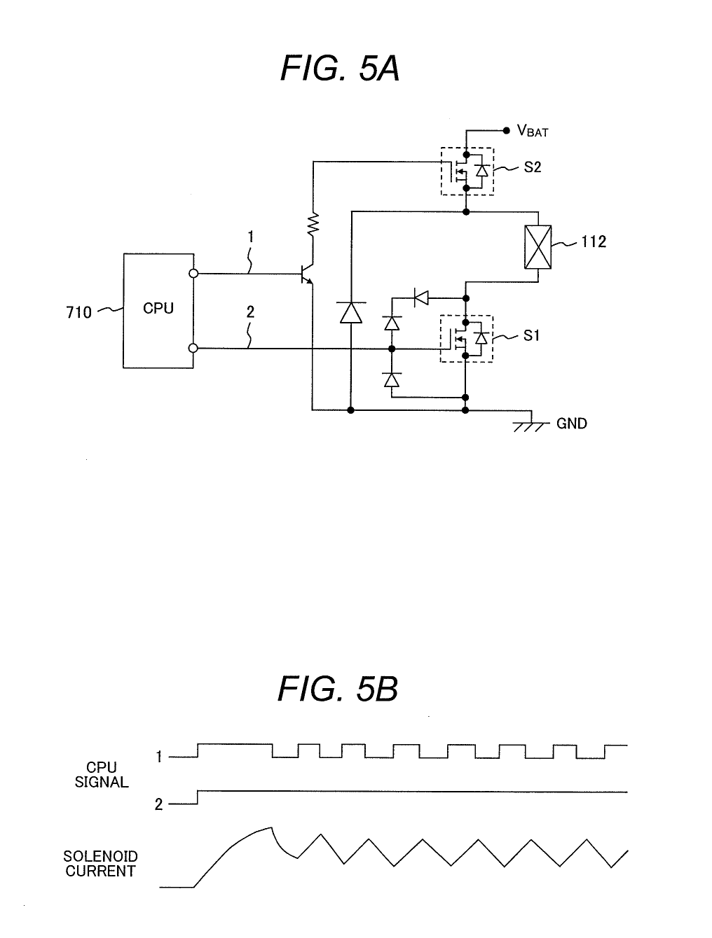

FIG. 5A shows a typical system for PWM control of coil 112 of the solenoid actuated intake valve 110. The PWM control system comprises two switches S1 and S2 that are controlled by a processing unit 710 (e.g. a CPU) of the engine control unit 700. The switches S1 and S2 may be, for example, embodied by field effect transistors (FET), i.e. electronic switches that can be switched by applying a voltage signal to a gate electrode of the field effect transistors controlled by CPU 710. Typically, such PWM control systems having two switches are usually controlled at a high frequency of the pulse-width modulation PWM (typically in the range of 1 to 10 kHz, preferably in the range of 2 to 6 kHz, most commonly about 4 kHz), wherein one switch (here in FIG. 5A: S2) is used to switch ON and OFF the PWM signal applied to the coil 112 according to the required pulse width modulation. The system is connected to a battery (battery voltage VBAT) and a ground potential (GND) or it may be connected to two poles of the battery. The switch S1 is used to do the PWM control and the switch S2 is used for fast deenergization of the solenoid, i.e. to ramp down the voltage quickly.

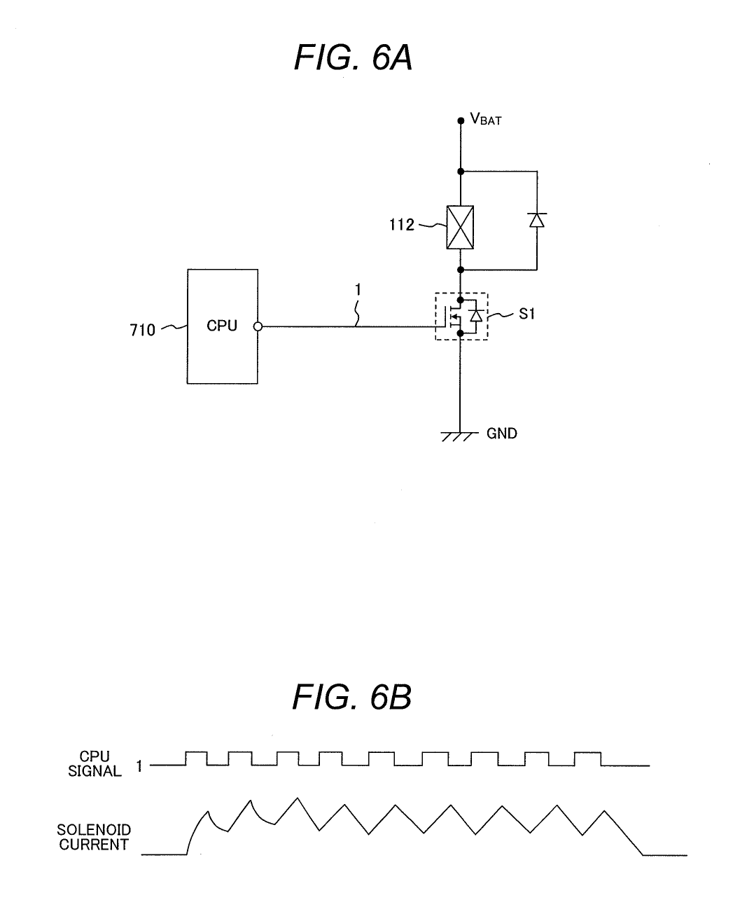

FIG. 6A shows an alternative typical system for PWM control of coil 112 of the solenoid actuated intake valve 110. The PWM control system comprises one switch S1 that is controlled by a processing unit 710 (e.g. a CPU) of the engine control unit 700. The switch S1 may be, for example, embodied by a field effect transistors (FET), i.e. an electronic switch that can be switched by applying a voltage signal to a gate electrode of the field effect transistors controlled by CPU 710. Typically, such PWM control systems having one switch are usually controlled at a lower frequency of the pulse-width modulation PWM (typically in the range of 100 to 1000 Hz, preferably in the range of 200 to 600 Hz, most commonly about 400 Hz). The system is connected to a battery (battery voltage VBAT) and a ground potential (GND) or it may be connected to two poles of the battery.

### First Embodiment

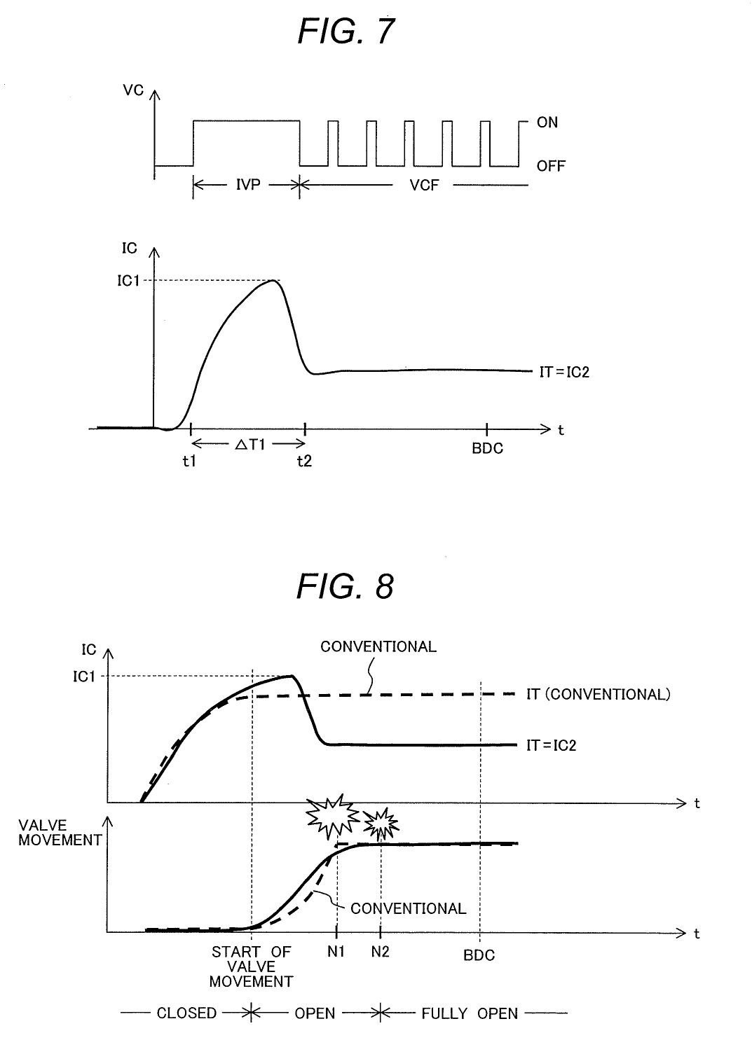

FIG. 7 shows the control of the control current IC of the solenoid actuated intake valve 110 according to a method for controlling a high-pressure fuel supply pump according to a first embodiment of the present invention. The upper row shows a PWM control voltage signal VC for controlling the control current IC according to the lower row in FIG. 7.

At a first point in time t1, before the movable compression plunger 130 reaches the bottom dead center position BDC and until a time t2 (with t2−t1=ΔT1), an initial voltage signal IVP is supplied to the coil 112 of the solenoid actuated intake valve 110 (e.g. a PWM voltage signal having 100% duty cycle) for increasing the control current IC to a control current value IC1 for energizing the solenoid actuated intake valve 110 for opening the valve. Starting from time t2, a PWM voltage signal VCF is applied to coil 112 of the solenoid actuated intake valve 110 having a duty cycle smaller than 100%, in particular a duty cycle that is set such that the control current is reduced from the current control value IC1 to a smaller control current value IC2 and such that the control current IC is substantially kept at this control current value IC2 for opening the valve up to the fully-opened position. For keeping the solenoid actuated intake valve fully open at the beginning of the compression phase in which the movable plunger 130 starts moving from the bottom dead center position towards the top dead center position TDC, the control current value IC2 is maintained, i.e. the control current value IC2 in this first embodiment of the present invention represents the target control current value IT for keeping the solenoid actuated intake valve 110 at the fully-opened position after the movable plunger 130 has reached the bottom dead center position BDC at the beginning of the compression phase so that fuel can spill out from the compression chamber 120 of the high-pressure fuel supply pump 100 through the fully open solenoid actuated intake valve 110.

FIG. 8 shows a comparison of the current control according to the first embodiment and current control as performed conventionally and as described with reference to FIG. 4 above. As mentioned above, according to the conventional current control (cf. the dashed line in FIG. 8), the control current IC is initially increased up to the target control value IT and thereafter kept substantially constant at the target control current IT. In contrast thereto, according to the present invention, the control current IC is controlled such that is increased to a current control value IC1 and thereafter decreased again to a control current value IC2 being the target control current value IT.

In particular, in FIG. 8, reducing the control current IC from the control current IC1 to the control current value IC2 is performed after the intake valve has started moving from the fully-closed position towards the fully-opened position. However, due to the reducing of the control current IC, as can be seen in the lower row of FIG. 8, the speed of the movement of the intake valve towards the fully-opened position is decelerated in comparison to the valve movement according to the conventional current control. This makes it possible to achieve a softer landing at the fully-opened position, when the intake valve member 111e comes in contact with the intake valve seat 111d at a time N2. After time N2, the intake valve is kept in the fully-closed position by means of the magnetic force induced by the control current IC2 in the coil 112.

However, according to the conventional current control, the intake valve member 111e hits the valve seat 111d with a higher speed at an earlier time N1, thereby producing a significantly louder impact noise. According to the control according to the first embodiment, the impact noise generated when the intake valve member 111e reaches the fully open position (when it comes in contact with the valve seat 111d) can be advantageously reduced.

### Second Embodiment

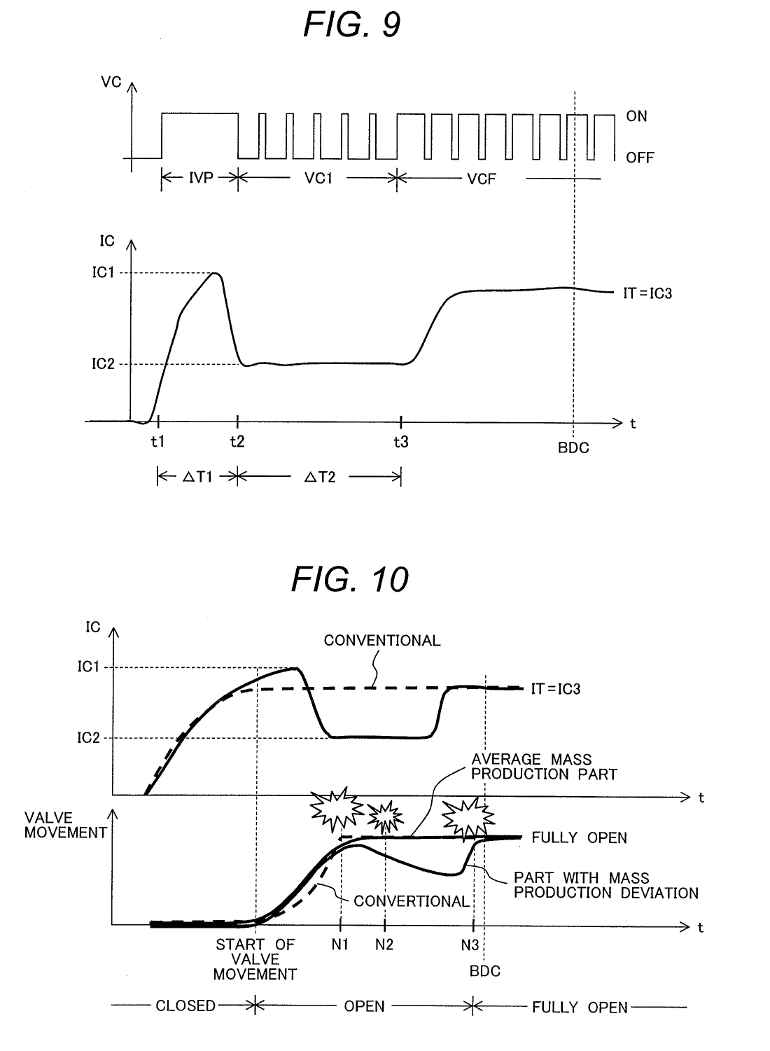

FIG. 9 shows the control of the control current IC of the solenoid actuated intake valve 110 according to a method for controlling a high-pressure fuel supply pump according to a second embodiment of the present invention. The upper row shows a PWM control voltage signal VC for controlling the control current IC according to the lower row in FIG. 9.

Similar to the first embodiment, at time t1 until time t2, an initial voltage pulse IVP is supplied for increasing the control current IC in the coil 112 up to a control current value IC1. Starting from time t2, a PWM voltage control signal VC1 is applied for decreasing the control current IC to the control current value IC2, similar to the first embodiment. This has the effect, that the movement of the intake valve member 111e towards the fully open position is decelerated after time t2 or at least the acceleration thereof is reduced.

For achieving an optimal deceleration of the movement of the intake valve member 111e towards the fully-opened position, the duty cycle of the voltage control signal VC1 can be set such that the control current IC2 is substantially the minimal value that is still sufficient to open and keep open an average solenoid actuated intake valve 110 in a mass production series (i.e. suitable to ensure that the average mass production solenoid actuated intake valve can keep the valve open during the compression phase). Then, due to mass production deviations, a situation may occur in which the mass production deviation may have the effect that the voltage control signal VC1 and the control current value IC2 are not sufficient to move the intake valve member 111e up to the fully open position prior to the time when the movable compression plunger 130 reaches bottom dead center position BDC since the magnetic force acting in the opening direction may become too small, the hydraulic force acting in the opening direction may become small sooner, and/or the biasing force acting in the closing direction may become too large. Then, due to a possible gap between anchor 111b and core 114 at the time when the compression plunger 130 reaches the bottom dead center position BDC, the resulting magnetic force may not be sufficient to keep open the intake valve when the movable compression plunger 130 starts moving upward again towards the top dead center position TDC. As soon as fuel is flowing through intake port 118 towards the intake valve member 111e so as to spill out of the compression chamber 120 through intake port 118 and intake passage 117, a hydraulic force acting on the intake valve member 111e in the closing direction of the intake valve may be generated.

According to the second embodiment, at a time t3, a further PWM voltage control signal VCF at a higher duty cycle compared to the PWM voltage control signal VC1 is applied for increasing again the control current IC up to a larger control current value IC3 before the movable compression plunger 130 reaches the bottom dead center position. This ensures that the intake valve becomes fully opened before the movable compression plunger 130 reaches the bottom dead center position BDC.

For an average solenoid actuated intake valve 110 of the mass production series, the control current IC2 may be set such that already the phase between times t2 and t3 is sufficient to smoothly land the intake valve member 111e on the valve seat 111d at the fully-opened position so that there is not gap between the anchor 111b and core 114. Then, magnetic force caused by the control current IC2 in coil 112 is sufficient to keep the intake valve fully open, even when the hydraulic force acting in the opening direction reduces again before the movable compression plunger 130 reaches the bottom dead center position BDC. In such an average scenario, increasing the control current IC from the control current value IC2 to the control current value IC3 will only further keep the intake valve in the fully open position, thereby generating no impact noise. However, in case the intake valve was not fully opened during the phase between time t2 and t3 due to possible mass production deviations, increasing the control current from the control current value IC2 to the control current value IC3 will increase the magnetic force that is attracting anchor 111b and core 114 so as to displace the intake valve member 111e up to the fully open position. This may lead to a louder impact noise compared to the average solenoid actuated intake valve 110 without mass production deviations that was already fully opened between time t2 and t3. However, it becomes possible to ensure that the solenoid actuated intake valve 110 reaches the fully-opened position before the movable compression plunger 130 reaches the bottom dead center position BDC so that it can be kept open, even in case of mass production deviations.

FIG. 10 schematically illustrates the evolution of the control current and the valve movement according to the second embodiment of the present invention. FIG. 10 illustrates the current control according to which the control current IC is first increased to the control current value IC1 to be then decreased to the control current value IC2 after the start of the movement of the intake valve and further to be increased again before the movable plunger 130 reaches the bottom dead center position BDC to the control current value IC3 being the final target control current value IT for keeping the intake valve in the fully-opened position after the movable compression plunger 130 has reached the bottom dead center BDC.

In the lower row of FIG. 10, the resulting valve movement is shown for an intake valve which is not fully closed during the phase of applying the control current value IC2 (between times t2 and t3 in FIG. 9) and moves again towards the fully-closed position due to the decreasing hydraulic force shortly before the compression plunger 130 reaches the bottom dead center position BDC. However, due to the increase of the control current IC from the current control value IC2 to the control current value IC3 shortly before the movable compression plunger 130 reaches the bottom dead center position BDC it can still be displaced up to the fully-opened position. Here, at a time N3, an impact noise is generated when the intake valve reaches the fully open position. However, it can be ensured that the intake valve can be kept in the fully open position after the compression plunger 130 has reached the bottom dead center position BDC, even in case of mass production deviations.

As further illustrated in FIG. 10, even when using the control according to the second embodiment, an average mass production series solenoid actuated intake valve 110 will show the same behavior as shown in FIG. 8, i.e. it is possible to achieve a soft landing at the fully-opened position at a time N2 at significantly reduced impact noise due to the decrease of the control current IC from the control current value IC1 to the control current value IC2. The dashed lines in FIG. 10 again correspond to the conventional current control as described with reference to FIG. 4.

As described above, according to the current control according to the second embodiment, in case of mass production deviation, it may occur that the solenoid actuated intake valve 110 is not fully opened by the reduced current control value IC2 and is thereafter fully opened by increasing the control current IC again to a higher target control current value IT, thereby possibly producing a higher impact noise but increasing the reliability of the control.

### Third Embodiment

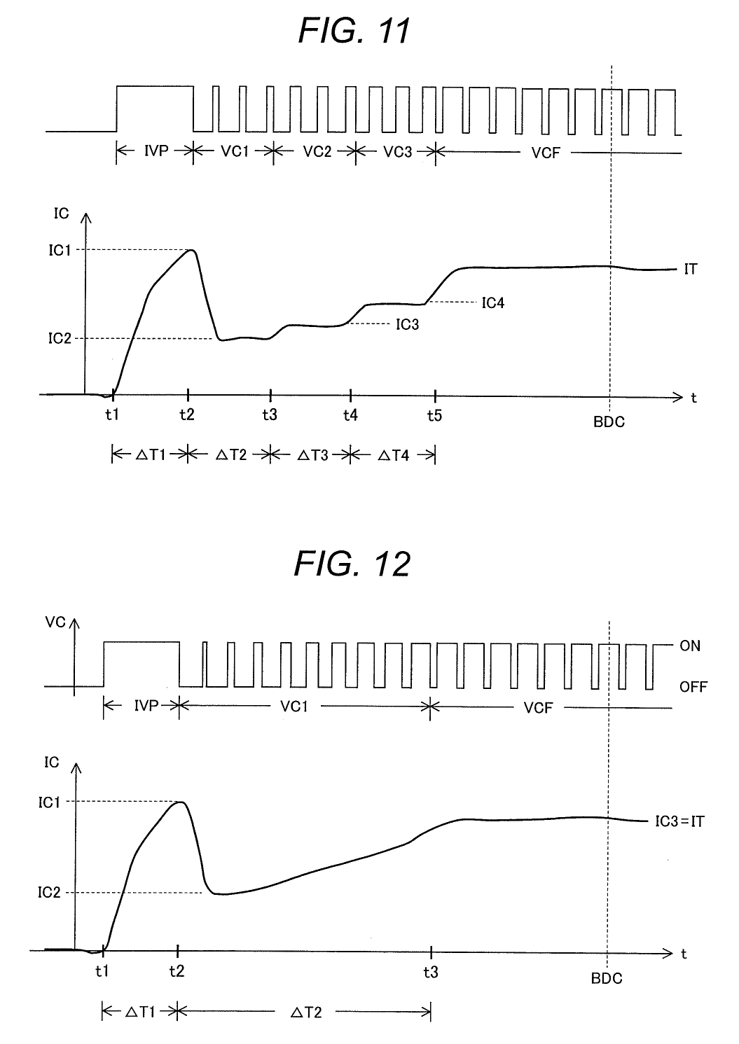

FIG. 11 shows the control of the control current IC of the solenoid actuated intake valve 110 according to a method for controlling a high-pressure fuel supply pump according to a third embodiment of the present invention. The upper row shows a PWM control voltage signal VC for controlling the control current IC according to the lower row in FIG. 11.

According to the third embodiment as illustrated with reference to FIG. 11, the increase from the current control value IC2 to the final target control current value IT for keeping the intake valve fully opened after the compression plunger 130 has reached the bottom dead center position, the control current IC is only gradually increased in order to ensure a soft landing at the fully-opened position even in case of mass production deviations described with reference to the second embodiment above.

According to the third embodiment, as illustrated in the upper row of FIG. 11, a plurality of PWM voltage control signals VC1, VC2, VC3, and VCF are applied after the initial voltage pulse IVP at times t2, t3, t4, and t5. Here, the duty cycle of the plural PWM voltage control signals from PWM voltage control signal VC1 to the final voltage control signal VCF is gradually increased according to a stepped PWM control in order to successively increase the control current IC from the control current value IC2 to the control current value IC3 to the control current value IC4 to the final target control current value IT for keeping the solenoid actuated intake valve 110 fully opened after the compression plunger 130 has reached the bottom dead center position BDC.

### Fourth Embodiment

FIG. 12 shows the control of the control current IC of the solenoid actuated intake valve 110 according to a method for controlling a high-pressure fuel supply pump according to a fourth embodiment of the present invention. The upper row shows a PWM control voltage signal VC for controlling the control current IC according to the lower row in FIG. 12.

According to FIG. 12, the control current IC is increased from the control current value IC2 to the final target control current value IT. However, different to the third embodiment described with reference to FIG. 11 above, between the initial voltage pulse IVP and the final PWM voltage control signal VCF, the duty cycle of the PWM voltage control signal VC1 is continuously (or iteratively, e.g. iteratively increasing of the durations of the ON conditions and/or decrease of the durations of the OFF conditions) increased between a time t2 and a time t3 (with t3−t2=ΔT2) so as to continuously increase the control current value IC2 to the final target control current value IT before the compression plunger 130 reaches the bottom dead center position BDC.

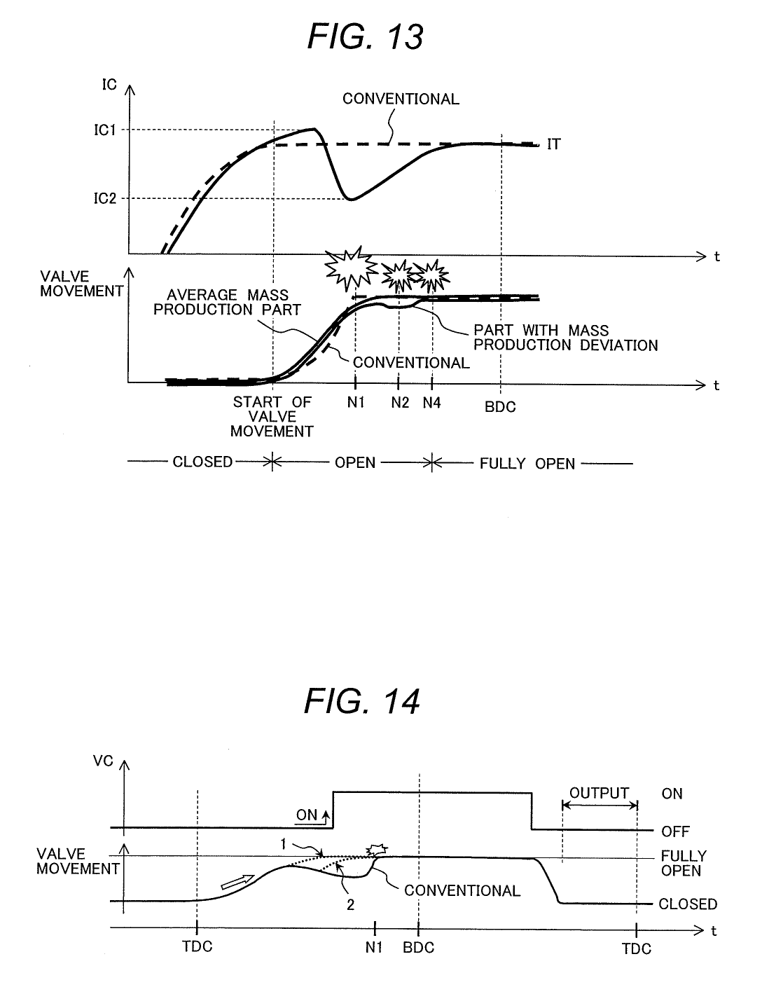

The effect of the control of the control current IC in coil 112 of the solenoid actuated intake valve 110 according to the fourth embodiment of the present invention is illustrated in FIG. 13. FIG. 13 illustrates in the upper row that the control current value IC2 is continuously increased up to the final target control current value IT. The dashed lines again refer to the conventional control as described with reference to FIG. 4. In the lower row of FIG. 13, it is shown that an average solenoid actuated intake valve 110 of a mass production series shows the similar behavior as described above with reference to FIG. 8. However, in case of possible mass production deviations in which the second control current value IC2 may not be sufficient to fully open the solenoid actuated intake valve 110, the continuous increase of control current ensures that the intake valve still reaches the fully opened position at a time N4, occurring at a lower impact speed when compared to the second embodiment, before the compression plunger 130 reaches the bottom dead center position BDC. The continuous increase of the control current value from the control current value IC2 to the target control current value IT allows for a smooth landing at time N4 of intake valve member 111e at intake valve seat 111d, thereby making it possible to significantly reduce the impact noise at high reliability, even in case of mass production deviations. Using the stepped PWM voltage control has similar advantages since the increase of the control current from the control current value IC2 to the target control current value IT is performed slower than according to the second embodiment.

### (Conventional Control Method)

FIG. 14 shows a comparison of the conventional control method as shown in FIG. 3 with control method according to the fourth embodiment of the present invention. The dashed curve labeled “1” shows the valve movement of an average mass production part that is controlled such that it lands smoothly at the fully-opened position at a significantly reduced impact noise. Due to the decrease of the control current value IC2 as illustrated in FIGS. 12 and 13, the speed of the intake valve movement before reaching the fully-opened position can be decelerated. The dashed curve labeled “2” shows the valve movement of a solenoid actuated intake valve that is not already fully opened by the reduced control current value IC2 but slightly thereafter due to the increase of the control current to the target control current value IT.

FIG. 15 schematically shows an example of a separate-type solenoid actuated intake valve. Different to the solenoid actuated intake valve shown in FIGS. 2A and 2B, the intake valve member 111e and the intake valve plunger 111a are formed as separate bodies that can move independently. Intake valve plunger 111a is biased in a closing direction by a biasing member, e.g. spring 113a, and intake valve member 111e is biased in a closing direction by another biasing member, e.g. spring 113b.

An anchor 111b is provided at the one end of the movable intake valve plunger 111a, i.e. at the end on the side opposite of the movable intake valve plunger 111a than the side on which the movable intake valve plunger 111a can come in contact with the intake valve member 111e. When current is applied to the coil 112, the anchor 111b and a core 114 of the solenoid valve are attracted to each other by magnetic force so that the movable intake valve plunger 111a is displaced in the direction of opening the valve until the anchor 111b and the core 114 come in contact so that the displacement of the movable intake valve plunger 111a is restricted. In this position, the intake valve plunger 111a can keep the intake valve member 111e in the fully opened position against the biasing force of the springs 113a and 113b.

As long as current is applied to the coil 112, the anchor 111b and the core 114 remain attracted to each other so as to stay in contact so that the valve can be kept open in that the intake valve member 111e is kept away from intake valve seat 111d. Accordingly, low-pressure fuel can be drawn from the low-pressure system via the intake passage 117 as indicated by the arrow and be delivered to the compression chamber 120 of the high-pressure fuel supply pump via the intake port 118 as further indicated by the arrow. Of course, non-pressurized fuel can also be spilled backwards through the intake port 118 via the intake passage 117 to the low-pressure fuel system as long as the valve is kept open by applying current to coil 112, when the compression plunger 130 in the compression chamber 120 is in an upward stroke so as to decrease the volume of the compression chamber 120.

However, when there is no current applied to the coil 112, the springs 113a and 113b bias the movable intake valve plunger 111a and the intake valve member 113b in the direction of closing the valve until the intake valve member 111e comes in contact with the intake valve seat 111d for closing the valve. The intake valve plunger 111a may be even further displaced in the closing direction by means of the biasing force of spring 113a. In an upward stroke of the compression plunger 130 in the compression chamber 120, fuel cannot spill out through the intake port 118 and fuel is pressurized in the compression chamber 120 so as to be discharged through the discharge valve 10 at high pressure. On the other hand, when there is no current applied to the coil 112, and the compression plunger 130 is in an intake stroke (downward stroke) so as to increase the volume of the compression chamber 120, the fuel pressure in the compression chamber 120 decreases in comparison to the pressure of fuel in the intake passage 117 which is connected to the low-pressure fuel system so that a hydraulic force is generated which can cause the displacement of the intake valve member 111e in the direction of opening the valve against the biasing force of the spring 113b even without applying current to the coil 112. The hydraulic force can either cause a full displacement of the movable intake valve member 111e or a displacement which is not a full displacement of the intake valve member 111e to the fully opened-position.

When current is applied to the coil 112, i.e. when the solenoid is energized, the magnetic force causes the intake valve plunger 111a to be displaced in the opening direction of the valve. Then, generally, according to conventional control of such separate-type solenoid actuated intake valves, there will occur two impact noises. The first impact noise is generated when the intake valve plunger 111a hits the intake valve member 111e and the second impact noise will be generated when the intake valve reaches the fully-opened position.

FIG. 16 illustrates an example of conventional control of a normally-closed solenoid actuated intake valve relating to the background of the present invention for a separate-type solenoid actuated intake valve. The upper row illustrates the movement of the movable compression plunger between the TDC top dead center position and the bottom dead center position BDC (referred to as “plunger lift”). The second row from the top illustrates the evolution of the control current IC and the lower row illustrates the corresponding movement of the intake valve member 111e and the intake valve plunger 111a. FIG. 16 illustrates the occurrence of the two impact noises that are successively produced at times N5 and N6.

The impact noise at time N6, i.e. when the intake valve reaches the fully opened position can be significantly reduced by current control according to the present invention as described above, in particular according to any of the above-mentioned embodiments. Furthermore, in the following, another embodiment will be described that makes it additionally possible to also reduce the first impact noise that is produced when the intake valve plunger 111a hits the intake valve member 111e.

### Fifth Embodiment

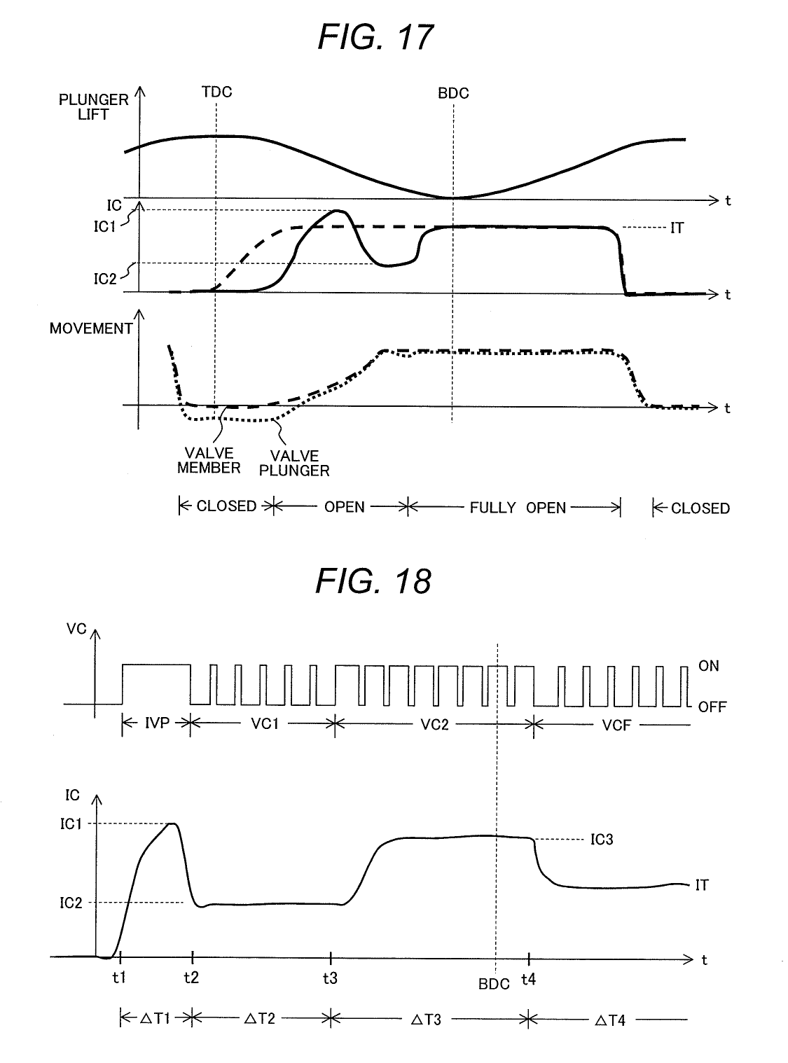

FIG. 17 schematically illustrates the evolution of the control current IC and the valve movement according to a fifth embodiment of the present invention. The upper row illustrates the movement of the movable compression plunger between the TDC top dead center position and the bottom dead center position BDC (referred to as “plunger lift”). The second row from the top illustrates the evolution of the control current IC (the dashed line corresponds to the conventional control described with reference to FIG. 16 above) and the lower row illustrates the corresponding movement of the intake valve member 111e and the intake valve plunger 111a.

Before the movable compression plunger 130 reaches the bottom dead center position BDC, the control current is increase to control current value IC 1, then decreased to control current value IC2, and thereafter increased again to the final target control current value IT similar to the current control according to the second embodiment. Alternatively, according to the first, third or fourth embodiment can be used.

Furthermore, the timing of the start of the increase of the control current IC, e.g. by setting a timing of an initial voltage pulse IVP as described above, is set to a timing after the intake valve member 111e has already started its movement in the opening direction by means of a hydraulic force. As shown in FIG. 17, the timing of the start of the increase of the control current IC is set such that the intake valve plunger 111a being displaced in the opening direction by the increasing magnetic force comes in contact with the intake valve member 111e when it is already moving in the opening direction due to the hydraulic force. Accordingly, the first impact noise that is typically generated when the intake valve plunger 111a hits the intake valve member 111e can be significantly reduced.

### Sixth Embodiment

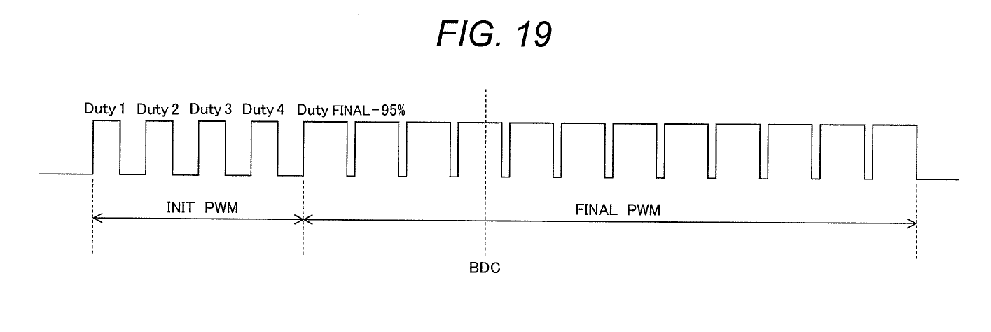

FIG. 18 illustrates the control method for controlling the control current in the solenoid 112 according to a sixth embodiment of the present invention. The control prior to the time at which the compression plunger 130 reaches the bottom dead center position BDC in FIG. 18 identically corresponds to the control as described with reference to FIG. 9 in connection with the second embodiment of the present invention.

However, after the compression plunger 130 has reached the bottom dead center position BDC and moves up again towards the top dead center position TDC, the control method according to the seventh embodiment further comprises a step of applying a final PWM control signal VCF at a time t4 after the compression plunger 130 has reached the bottom dead center position BDC having a smaller duty cycle than the previously applied PWM voltage control signal VC2 for decreasing the control current IC3 in FIG. 18 to a smaller target control current value IT that is still sufficient to kept the intake valve at the fully-opened position even during the compression phase when the movable compression plunger 130 moves towards the top dead center position TDC.

In addition to the advantages of the above described second embodiment of the present invention, this sixth embodiment of the present invention makes it further possible to reduce energy consumption and to avoid thermal overload in the coil 112 due to the decreased target control current value IT that is maintained for keeping the intake valve in the fully open position.

FIG. 19 shows an alternative evolution of a PWM voltage control signal. In the above described embodiments, PWM control of the solenoid(s) was exemplarily achieved via a single-switch or dual-switch PWM control. When single-switch control is used, the PWM frequency can be in general quite low, and is typically between 100 and 800 Hz, preferably between 300 and 600 Hz, more preferably equal to or at least substantially 400 Hz (which is equivalent to a period of 2.5 ms). This is relatively slow relative to the mechanical motion of the valve so that the valve will typically reach the mechanical stop after the first few PWM periods. In such cases, a ‘soft-landing’ of the valve in the fully open position (i.e. with substantially no impact noise due to a decelerated impact speed being substantially zero) can be also be implemented. This can be achieved by using different duty-cycles for the first few cycles, and thereafter increasing the duty-cycle before reaching the bottom dead center position BDC for ensuring that the inlet valve reaches the fully-open position before the start of the compression stroke.

The actual values of the first PWM periods can be determined for each operating condition, in consideration of the so-called P_ON timing (i.e. the time of start of initial energization of the solenoid(s) relative to the time of the top dead center position TDC of the pump) and the engine speed. For minimum noise generation, the inlet valve preferably reaches the mechanical stop during a time when the PWM voltage control signal is in an OFF condition, or at the start of the pulse. The methods indicated earlier can be used during the calibration process to enable the determination of the instance of landing of the valve in the fully open position. In any condition, the switching to a higher PWM duty-cycle before the start of the compression cycle (between bottom dead center position and top dead center position) ensures that the inlet solenoid(s) reaches the fully-open condition regardless of any changes in the operating conditions or regardless of mass production deviations.

The calibration procedure may involve the determination of a few distinct PWM duty cycles (for the first few cycles). In FIG. 10, exemplarily, four duty cycles “Duty 1”, “Duty 2”, “Duty 3” and “Duty 4” are shown (labelled “init PWM”). Typically, the inlet solenoid valve can reach the fully-open position either within the first two, three or four cycles, unless the values are too low in which case it will be brought to fully-open position by the final PWM duty cycle which has a sufficiently higher duty cycle, preferably approximately 95% duty cycle.

Accordingly, one possible configuration is to use a stepped PWM control, whereby:

“Duty 1”=“Duty 2”=“Duty 3”=“Duty 4” for the entire init PWM duration (e.g., 75% duty cycle); and

Duty cycle of final PWM is approximately 95% (or another sufficiently high value between 85% to 100% duty cycle, preferably between 90% and 100% duty cycle).

Another possible configuration is to ramp up the PWM voltage signal duty cycle in the init PWM duration, or to use a large first duty cycle (such as an initial voltage pulse), followed by a lower duty cycle in the second period (Duty 2), etc. A large duty cycle should be used before reaching the bottom dead center position BDC to guarantee that the valve is surely fully open before the start of compression phase). This algorithm can be generalized as:

Duty 1;Duty 2=Duty 1+a;Duty 3=Duty 2+b;Duty 4=Duty 3+c; etc.
where a, b, c, . . . can be determined during the calibration process (typically about +7-5%).
Then, before reaching BDC, a constant large duty cycle is used:
Duty final=Duty F (e.g. 95% duty cycle).

Features, components and specific details of the structures of the above-described embodiments may be exchanged or combined to form further embodiments optimized for the respective application. As far as those modifications are apparent for an expert skilled in the art they shall be disclosed implicitly by the above description without specifying explicitly every possible combination.

What is claimed is:

1. Method for controlling a high-pressure fuel supply pump configured to supply pressurized fuel to an internal combustion engine, the high-pressure fuel supply pump comprising a normally-closed type solenoid actuated intake valve configured to be opened or kept open by magnetic force,
said method comprising controlling a control current of the solenoid actuated intake valve for opening the solenoid actuated intake valve,
wherein controlling a control current of the solenoid actuated intake valve comprises increasing the control current to a first control current value for energizing the solenoid actuated intake valve,
characterized in that
controlling a control current of the solenoid actuated intake valve for opening the solenoid actuated intake valve further comprises reducing the control current from the first control current value to a second control current value being smaller than the first control current value.

2. Method for controlling a high-pressure fuel supply pump according to claim 1, characterized in that the control current is reduced from the first control current value to the second control current value before the solenoid actuated intake valve is fully opened.

3. Method for controlling a high-pressure fuel supply pump according to claim 1, characterized in that the second control current value is a non-zero current value being smaller than the first control current value or the second control current value is zero or at least substantially zero.

4. Method for controlling a high-pressure fuel supply pump according to claim 1, characterized in that controlling the control current of the solenoid actuated intake valve for opening the solenoid actuated intake valve further comprises increasing the control current from the second control current value to a third control current value being larger than the second control current value.

5. Method for controlling a high-pressure fuel supply pump according to claim 4, characterized in that
the high-pressure fuel supply pump further comprises a compression chamber and a movable plunger reciprocating in the compression chamber between a bottom dead center position (BDC) and a top dead center position (TDC) for pressurizing fuel in said compression chamber when said solenoid actuated intake valve is fully closed and said movable plunger moves to said top dead center position (TDC), and
said increasing the control current from the second control current value to the third control current value is performed before the movable plunger reaches the bottom dead center position (BDC) for ensuring that the solenoid actuated intake valve becomes fully opened before said movable plunger reaches said bottom dead center position (BDC).

6. Method for controlling a high-pressure fuel supply pump according to claim 4, characterized in that
said third control current value is a target control current value for keeping the solenoid actuated intake valve fully opened, in particular said third control current value is a target control current value for keeping the solenoid actuated intake valve fully opened after said movable plunger has reached said bottom dead center position (BDC); or
controlling the control current of the solenoid actuated intake valve further comprises reducing said third control current value to a target control current value after solenoid actuated intake valve is fully opened for keeping the solenoid actuated intake valve fully opened, in particular controlling the control current of the solenoid actuated intake valve further comprises reducing said third control current value after said movable plunger has reached said bottom dead center position (BDC) to a target control current value after the solenoid actuated intake valve is fully opened for keeping the solenoid actuated intake valve fully opened after said movable plunger has reached said bottom dead center position (BDC), said target control current value being smaller than the third control current value for reducing energy consumption.

7. Method for controlling a high-pressure fuel supply pump according to claim 1, characterized in that controlling the control current of the solenoid actuated intake valve is performed by controlling a duty cycle of a PWM voltage signal supplied to the solenoid actuated intake valve, by controlling a duty cycle and a frequency of a PWM voltage signal supplied to the solenoid actuated intake valve, or by controlling the value of a voltage signal supplied to the solenoid actuated intake valve.

8. Method for controlling a high-pressure fuel supply pump according to claim 1, characterized in that controlling the control current of the solenoid actuated intake valve further comprises
applying an initial voltage pulse for increasing the control current to the first control current value, and
applying a first PWM voltage signal after applying the initial voltage pulse for reducing the control current from the first control current value to the second control current value.

9. Method for controlling a high-pressure fuel supply pump according to claim 8, characterized in that controlling the control current of the solenoid actuated intake valve further comprises applying a second PWM voltage signal after applying the first PWM voltage signal for increasing the control current from the second control current value to a third control current value being larger than the second control current value, in particular wherein said first PWM voltage signal has a smaller duty cycle than the second PWM voltage signal.

10. Method for controlling a high-pressure fuel supply pump according to claim 9, characterized in that
the first PWM voltage signal is switched to the second PWM voltage signal;
the first PWM voltage signal is changed according to a stepped PWM control to the second PWM voltage signal, wherein at least a third PWM voltage signal is applied after the first PWM voltage signal and before the second PWM voltage signal, wherein the duty cycle of the third PWM voltage signal is larger than the duty cycle of the first PWM voltage signal and smaller than the duty cycle of the second PWM controlled voltage signal; or
the duty cycle of the first PWM voltage signal is continuously or iteratively increased according to a ramped up PWM control to the duty cycle of the second PWM controlled voltage signal.

11. Method for controlling a high-pressure fuel supply pump according to claim 8, characterized in that controlling the control current of the solenoid actuated intake valve further comprises at least one of:
setting a timing (t1) of the start of applying the initial voltage pulse,
setting a duration (ΔT1) of applying the initial voltage pulse, and
setting a timing (t2) of applying the first PWM voltage signal and/or a duration (ΔT2) of applying the first PWM voltage signal,
wherein said setting of timings and durations of said initial voltage pulse and said first PWM voltage signal is performed for controlling a magnetic force of the solenoid actuated intake valve in dependence of a hydraulic force acting in an opening direction of the solenoid actuated intake valve and a biasing force acting in a closing direction of the solenoid actuated intake valve.

12. Method for controlling a high-pressure fuel supply pump according to claim 11, characterized in that controlling the control current of the solenoid actuated intake valve further comprises:
setting a timing of applying the second PWM voltage signal and/or a duration of applying the second PWM voltage signal,
wherein said setting of timings and durations of said initial voltage pulse, said first PWM voltage signal, and said second PWM voltage signal is performed for controlling said magnetic force in dependence of said hydraulic force and said biasing force.

13. Method for controlling a high-pressure fuel supply pump according to claim 11, characterized in that the timing of applying the initial voltage pulse is set before the occurrence of a maximum hydraulic force acting in an opening direction of the solenoid actuated intake valve.

14. Method for controlling a high-pressure fuel supply pump according to claim 11, characterized in that the setting of timings and durations of said initial voltage pulse and said first PWM voltage signal or said first and second PWM voltage signals are set such that the solenoid actuated intake valve reaches its fully opened position at a timing when said PWM control is in a low current condition.

15. Method for controlling a high-pressure fuel supply pump according to claim 1, characterized in that said solenoid actuated intake valve is a separate-type solenoid actuated intake valve having an intake valve member and an intake valve plunger being formed as separate members, wherein the magnetic force of the solenoid actuated intake valve acts on the intake valve plunger and a timing of the start of the increase of the control current to the first control current value for energizing the solenoid actuated intake valve is set to a timing after said intake valve member starts moving caused by a hydraulic force acting in an opening direction of the intake valve member, in particular such that the intake valve plunger comes in contact with the intake valve member when the intake valve member moves in the opening direction of the intake valve member.

16. A control apparatus for controlling a high-pressure fuel supply pump configured to supply pressurized fuel to an internal combustion engine, characterized in that said control apparatus is adapted to control a control current of the solenoid actuated intake valve for opening the solenoid actuated intake valve according to a method for controlling a high-pressure fuel supply pump according to claim 1.

17. A computer program product comprising computer program code means configured to adapt a control apparatus, in particular an engine control unit, such that the control apparatus is adapted to control a control current of the solenoid actuated intake valve for opening the solenoid actuated intake valve according to a method for controlling a high-pressure fuel supply pump according to claim 1.
